(19) United States
(12) Patent Application Publication
(10) Pub. No.: US 2009/0070295 A1
(43) Pub. Date: Mar. 12, 2009

(54) DOCUMENT PROCESSING DEVICE AND DOCUMENT PROCESSING METHOD

(75) Inventors: Nobuyuki Otomori, Tokushima-shi (JP); Yusuke Fujimaki, Tokushima-shi (JP); Yasuo Akai, Tokushima-shi (JP); Toshio Ueda, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi, Tokushima (JP)

(21) Appl. No.: 11/913,602

(22) PCT Filed: May 9, 2006
(86) PCT No.: PCT/JP2006/309337

§ 371 Date: Nov. 5, 2007

(30) Foreign Application Priority Data
May 9, 2005 (JP) 2005-135764

(51) Int. Cl. G06F 7/06; G06F 17/30

(52) U.S. Cl. 707/3; 707/E17.014

(57) ABSTRACT

Convenience of a user is improved in handling data included in a plurality of structured document files. A child document file is created by a schema inheriting a schema in a parent document file in which a plurality of tags are structured. A name of a substance tag in a child document file inheriting a model tag included in a parent document file is changeable in accordance with a user's input direction. At the time, a tag mapping table is held, in which a name of a substance tag included in a child document file and a name of a model tag which is the origin of the substance tag are associated with each other. A name of a substance tag corresponding to a model tag of which name is a search key is detected, with reference to the tag mapping table, and then, the data of the substance tag is detected from the child document file, by using the name of the substance tag as a new search key.

### FIELD OF THE INVENTION

The present invention relates to a data processing technology, in particular, to a technology in which document data is structured and processed.

### BACKGROUND OF THE INVENTION

With the spread of computers and progress of network technologies in recent years, exchange of the electronic information via networks is active. Due to this, a lot of paperwork conventionally performed on the basis of paper is being replaced by network-based processing.

Also in companies, what is called knowledge management that utilizes individual knowledge and information in the whole organization is becoming an important business method. In many companies, in-house database systems are implemented and pieces of information from employees are electronically filed and accumulated. On the other hand, employees also access the files accumulated in the in-house database via a network. Due to this, the operating efficiency as the whole organization can be improved.

Many of files accumulated in the in-house database are created by using the language called HTML (Hyper Text Markup Language). Furthermore, cases have been increasing in recent years, where those files are created by using the language called XML (eXtensible Markup Language).

HTML is a language for describing a web page. That is, HTML is a type of a markup language which defines a display method of a document file. On the other hand, XML is considered to be a language which has a function for defining a data structure of data included in a document file rather than a language aiming at describing a web page directly like HTML. A document file created by using XML is displayed as a web page by giving display layout information separately. That is, in an XML document, a structure of data and a display layout thereof can be handled as being separate from each other. Like XML, a language for creating a markup language is also called a metalanguage.

XML attracts attention as a form suitable for sharing data with others via a network etc., and applications for creating, displaying and editing XML documents are developed (for example, see Patent Document 1). An XML document is created based on a vocabulary (tag set) defined by a document type definition etc.

Patent documents 1: Japanese Patent application Laid-open Publication No. 2001-290804.

### DISCLOSURE OF THE INVENTION

### Problems to be Solved by the Invention

In many divisions of a company, various types of document files including personal information are usually made available in original formats (which are structured by XML). Security managers need to manage personal information data in order to prevent a disclosure of personal information from happening. However, such personal information data is registered in local terms understood in each division. For example, in the sales division, “name” and “address” are registered as “customer information”, whereas that are registered as “data source” in the research and development division as well. Furthermore, a display layout on a browser screen for inputting these data is developed separately in a unit of each division in many cases. Therefore, if customer information is managed so as not to be disclosed externally, following work will be required as a change of the system.

1. A security manager checks personal information included in a document file, such as a business record handled in each division.
2. Work of giving an annotation which shows “Caution: Personal Information” to the personal information included in such a business record, and creation of a personal information database, as an in-house system.
3. Change of input screens used in each division. These types of work are very costly.

The present invention is to provide a technology which can improves users' convenience in handling data included in a plurality of structured document files.

### Means for Solving the Problem

In order to solve aforementioned problems, a document processing apparatus of an embodiment of the present invention includes: a file holding unit which holds a child document file created by a schema inheriting a schema of a parent document file in which a plurality of tags are structured; a tag renaming processing unit which changes a name of a substance tag, which is a tag in a child document file inheriting a model tag included in a parent document file, in accordance with a user's input direction; a tag mapping table holding unit which holds a tag mapping table in which a name of a substance tag included in a child document file and a name of a model tag which is the origin of the substance tag, are associated with each other; and a tag data search unit which detects a name of a substance tag corresponding to a model tag, by a user's search direction input in which the name of the model tag is a search key, with reference to the tag mapping table, and further detects the data of the substance tag from a child document file, by using the name of the substance tag as a new search key.

Furthermore, this apparatus may be provided with a filtering processing unit which classifies tags included in a document file in accordance with a filtering condition which defines a type of tag to be filtered. The filtering processing unit may identify a model tag to be a target of classification and extraction, in accordance with a filtering condition, and may perform classification and extraction of the data to be filtered, by ordering the tag data search unit to detect the data of a substance tag by using the name of the model tag as a search key. In such an embodiment, when a tag into which, for example, the data unsuitable for displaying or transmitting externally is inputted is defined as a filtering condition, it will become easier to extract the data having such a specific attribute from a document file.

This apparatus may further include a related tag search unit which detects a model tag which is the origin of the substance tag specified by a user, with reference to a tag mapping table, and detects other substance tag inheriting the model tag, with reference to a plurality of tag mapping tables which are held in the tag mapping table holding unit.

Another embodiment of the present invention is also a document processing apparatus. This apparatus includes: a file holding unit which holds a child document file created by a schema inheriting a schema of a parent document file in which a plurality of tags are structured; an annotation renaming processing unit which changes a name of a substance annotation which is an annotation in a child document file inheriting a model annotation included in a parent document file, in accordance with a user's input direction; an annotation mapping table holding unit which holds an annotation mapping table in which a name of a substance annotation included in a child document file and a name of a model annotation which is the origin of the substance annotation, are associated with each other; an annotation setting unit which sets a substance annotation in the data which is included in a child document file and specified by a user; and an annotation data search unit which detects a name of a substance annotation which corresponds to a model annotation, by a user's search direction input in which the name of the model annotation is a search key, with reference to the annotation mapping table, and further detects the data in which the substance annotation is set from a child document file, by using the name of the substance annotation as a new search key.

This apparatus may further include a file transmitting unit which transmits a child document file to an external apparatus. Using a model annotation as a search key, the annotation data search unit may detect the data corresponding to the model annotation from the data included in a child document file, wherein the model annotation is an annotation which shows prohibition of data from being transmitted externally. The file transmitting unit may deter the data detected from being transmitted to an external apparatus.

Another embodiment of the present invention is also a document processing apparatus. This apparatus includes: a document acquisition unit which acquires a structured document file described by a substance tag which belongs to a predetermined tag set; a correspondence detecting unit which detects a substance tag included in the structured document file, and detects a model tag which is in a predetermined relation with the substance tag detected, among model tags which belong to a tag set different from the predetermined tag set; a mapping recording unit which associates the substance tag and the model tag which are in the predetermined relation with each other, and records the tags in a tag mapping table; and a tag search unit which, upon receiving a user's search direction input in which the model tag is a search key, detects the element data of the substance tag associated with the model tag in a tag mapping table, from a structured document file.

This apparatus may further include: a data display unit which displays data included in a structured document file; and a display control unit which, upon receiving a user's direction input in which a model tag corresponding to the element data which is not a display target is specified, detects a substance tag associated with the model tag in the tag mapping table, and excludes the element data identified by the substance tag in the structured document file, from a display target.

The correspondence detecting unit of the apparatus may detect a model tag of which name is in a synonym relation with the name of the substance tag detected from the structured document file, as a model tag which is in a predetermined relation with the substance tag, with reference to a synonym data table in which a combination of words which are in a synonym relation with each other is defined.

The correspondence detecting unit of the apparatus may detect a model tag of which name is a superordinate concept covering the name of the substance tag detected from the structured document file, as a model tag which is in a predetermined relation with the substance tag, with reference to a conceptual data table in which a combination of words which are in a relation between the superordinate concept and the subordinate concept is defined.

Note that any combination of the aforementioned components or any component or manifestation of the present invention exchanged between methods, apparatuses, systems, computer programs, recording mediums storing computer programs, data structures, and so forth, is effective as an embodiment of the present invention.

### EFFECT OF THE INVENTION

According to the present invention, the invention is effective for improving the convenience of a user in handling data included in a plurality of structured document files.

### BRIEF DESCRIPTION OF THE DRAWINGS

FIG. 1 is a diagram which shows a configuration of a document processing apparatus according to the base technology;

FIG. 2 is a diagram which shows an example of an XML document which is a processing target;

FIG. 3 is a diagram which shows an example in which the XML document shown in FIG. 2 is mapped to a table described in HTML;

FIG. 4(a) is a diagram which shows an example of a definition file used for mapping the XML document shown in FIG. 2 to the table shown in FIG. 3;

FIG. 4(b) is a diagram which shows an example of a definition file used for mapping the XML document shown in FIG. 2 to the table shown in FIG. 3;

FIG. 5 is a diagram which shows an example of a screen on which the XML document, which has been described in a marks managing vocabulary shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11(a) is a diagram which shows a basic configuration of a document processing system;

FIG. 11(b) is a block diagram which shows an overall block configuration of a document processing system;

FIG. 11(c) is a block diagram which shows an overall block configuration of a document processing system;

FIG. 12 is a diagram which shows a document management unit in detail;

FIG. 13 is a diagram which shows a vocabulary connection sub-system in detail;

FIG. 14 is a diagram which shows a relation between a program invoker and other components in detail;

FIG. 15 is a diagram which shows a structure of an application service loaded to the program invoker in detail;

FIG. 16 is a diagram which shows a core component in detail;

FIG. 17 is a diagram which shows a document management unit in detail;

FIG. 18 is a diagram which shows an undo framework and an undo command in detail;

FIG. 19 is a diagram which shows the operation in which a document is loaded to the document processing system;

FIG. 20 is a diagram which shows an example of a document and a representation of the document;

FIG. 21 is a diagram which shows a relation between a model and a controller;

FIG. 22 is a diagram which shows a plug-in sub-system, a vocabulary connection, and a connector, in detail;

FIG. 23 is a diagram which shows an example of a VCD file;

FIG. 24 is a diagram which shows a procedure for loading a compound document to the document processing system;

FIG. 25 is a diagram which shows a procedure for loading a compound document to the document processing system;

FIG. 26 is a diagram which shows a procedure for loading a compound document to the document processing system;

FIG. 27 is a diagram which shows a procedure for loading a compound document to the document processing system;

FIG. 28 is a diagram which shows a procedure for loading a compound document to the document processing system;

FIG. 29 is a diagram which shows a command flow;

FIG. 30 is a schematic diagram which shows layer cakes of the Semantic Web;

FIG. 31 is a schematic diagram which shows a general form of handling various document files including personal information;

FIG. 32 is a diagram which shows a flow of the personal information management support system of the present embodiment;

FIG. 33 is a schematic diagram which explains the scene 1 of FIG. 32 in detail;

FIG. 34 is a diagram which shows a relation between a global ontology and local ontology in the research division;

FIG. 35 is a diagram which shows a relation between a global ontology and local ontology in the sales division;

FIG. 36 is a schematic diagram which explains a manner in which an annotation is given to a child document file;

FIG. 37 is a schematic diagram which explains the security management by an annotation;

FIG. 38 is a diagram which shows another example of the tag mapping table explained in relation to FIGS. 34 and 35;

FIG. 39 is a functional block diagram of a document processing apparatus which realizes a function for mapping substance tags to model tags, using the various functions of the document processing apparatus explained in the base technology;

FIG. 40 is a schematic diagram which explains a mapping structure for mapping model tags to substance tags.

### REFERENCE NUMERALS

20 document processing apparatus
22 main control unit
24 editing unit
30 DOM unit
32 DOM provider
34 DOM builder
36 DOM writer
40 CSS unit
42 CSS parser
44 CSS provider
46 rendering unit
50 HTML unit
52, 62 control unit
54, 64 editing unit
56, 66 display unit
60 SVG unit
80 VC unit
82 mapping unit
84 definition file acquisition unit
86 definition file creating unit
3000 document processing apparatus
3100 user interface processing unit
3110 input unit
3112 annotation setting unit
3114 document acquisition unit
3120 display unit
3130 communication unit
3132 document transmitting unit
3134 document receiving unit
3200 data processing unit
3210 document editing unit
3212 tag renaming unit
3214 annotation renaming unit
3220 search unit
3222 tag search unit
3224 annotation search unit
3230 mapping processing unit
3232 correspondence detecting unit
3234 mapping recording unit
3240 masking processing unit
3250 data holding unit
3252 file holding unit
3254 tag mapping table holding unit
3256 annotation mapping table holding unit

### BEST MODE FOR CARRYING OUT THE INVENTION

The base technology in the present embodiment will be described below, followed by the explanation with respect to the features of the present invention.

### (Base Technology)

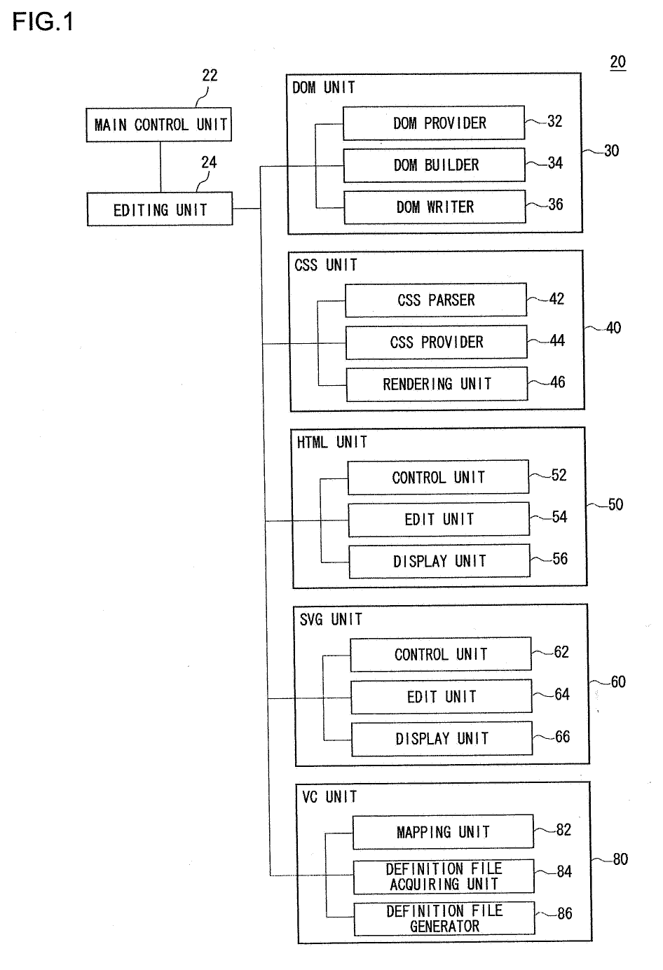

FIG. 1 illustrates a structure of a document processing apparatus 20 according to the Base technology. The document processing apparatus 20 processes a structured document where data in the document are classified into a plurality of components having a hierarchical structure. Represented in the base technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the base technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the base technology, this function is called a vocabulary connection (VC) In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

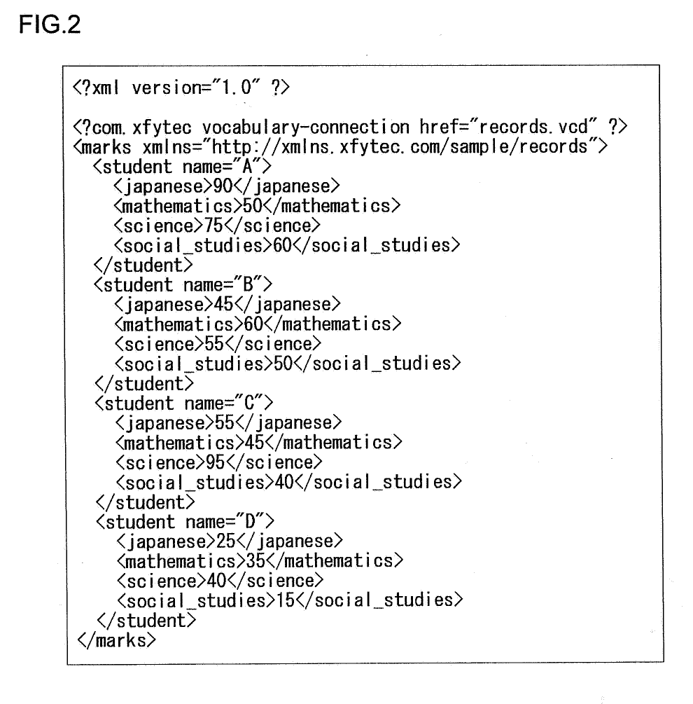

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the base technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

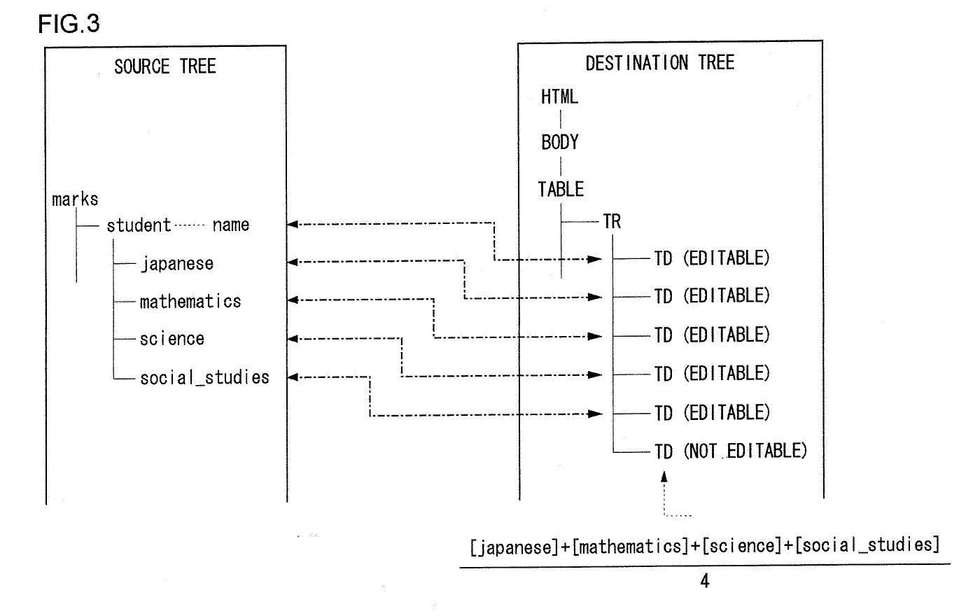

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

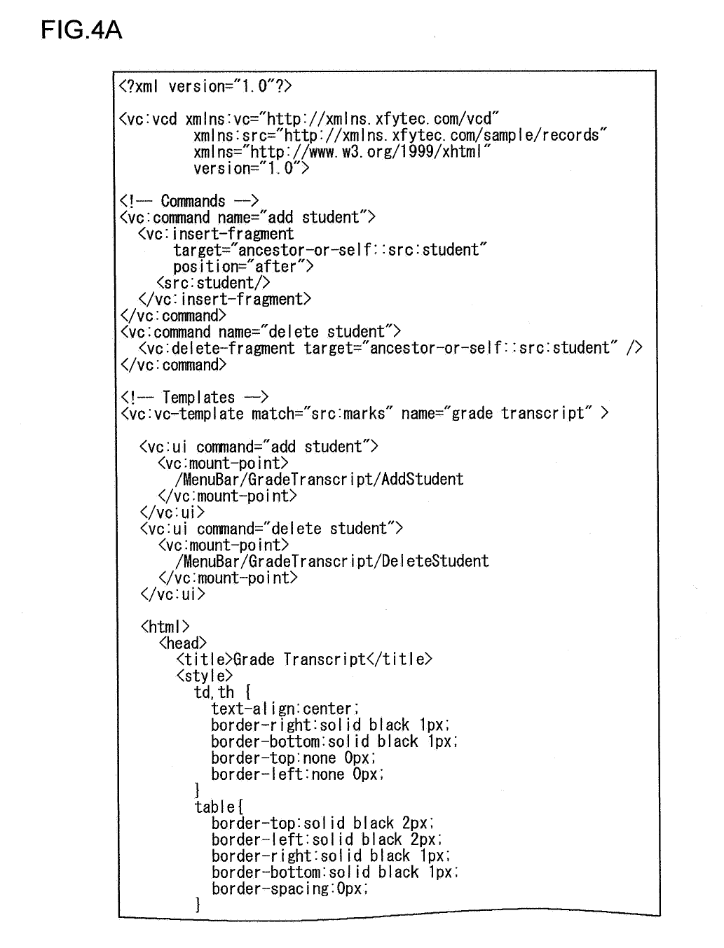

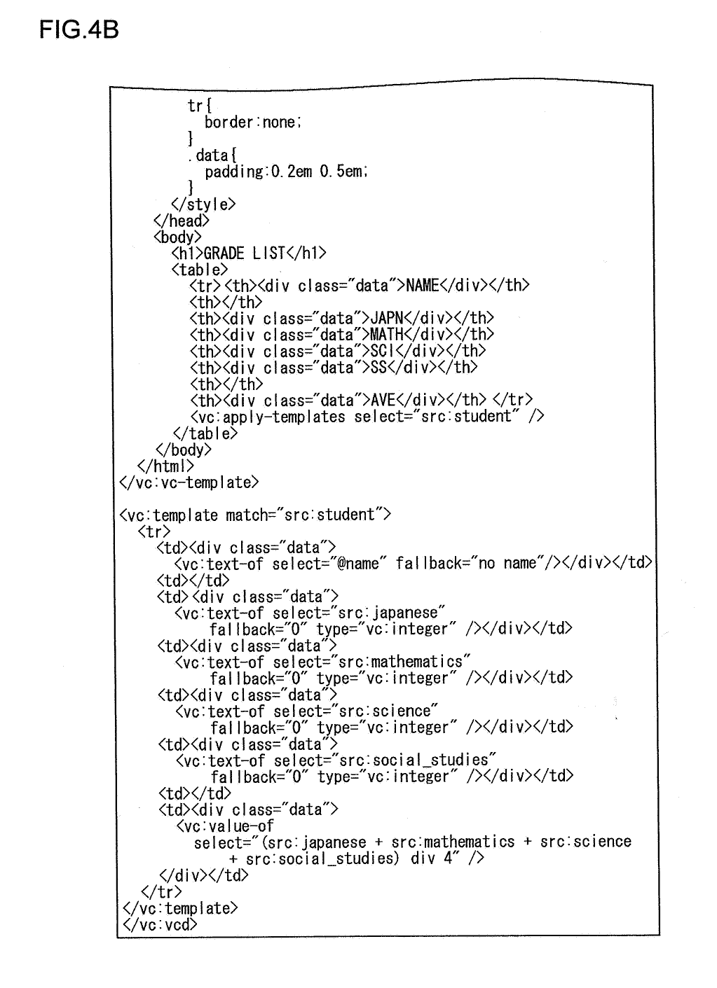

FIG. 4(a) and FIG. 4(b) illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4(a) and FIG. 4(b), “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

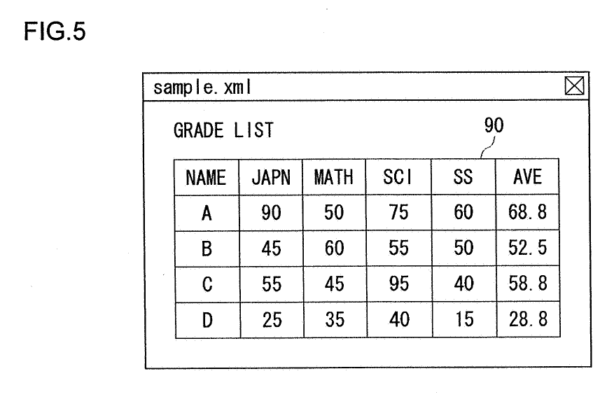

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4(a) and FIG. 4(b). When the user selects a command from among these commands, a Node “student” is added or deleted in the source tree. In this manner, with the document processing apparatus 20 according to the base technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

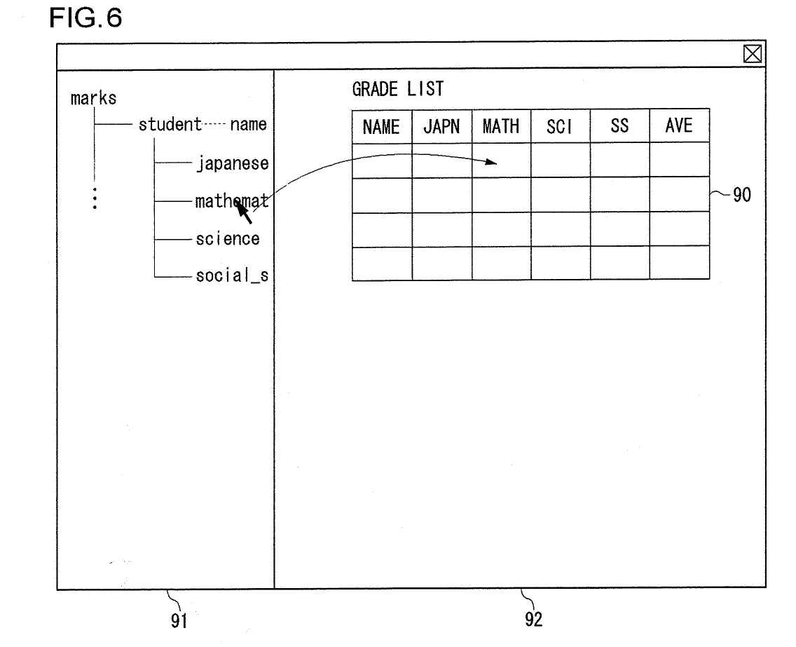

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

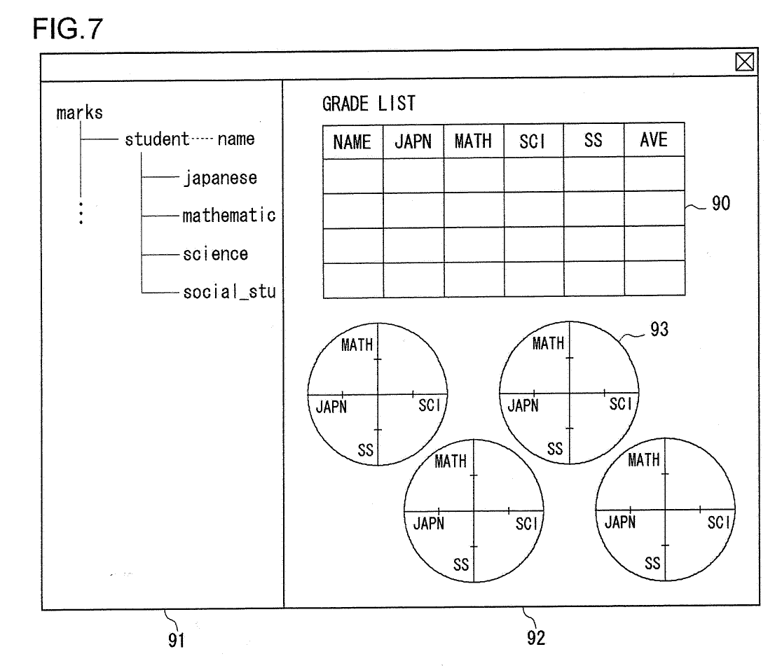

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the base technology can process a compound document described in the form of a single XML document according to a plurality of vocabularies. That is why the table 90 described in HTML and the circular graphs 93 described in SVG can be displayed on the same screen.

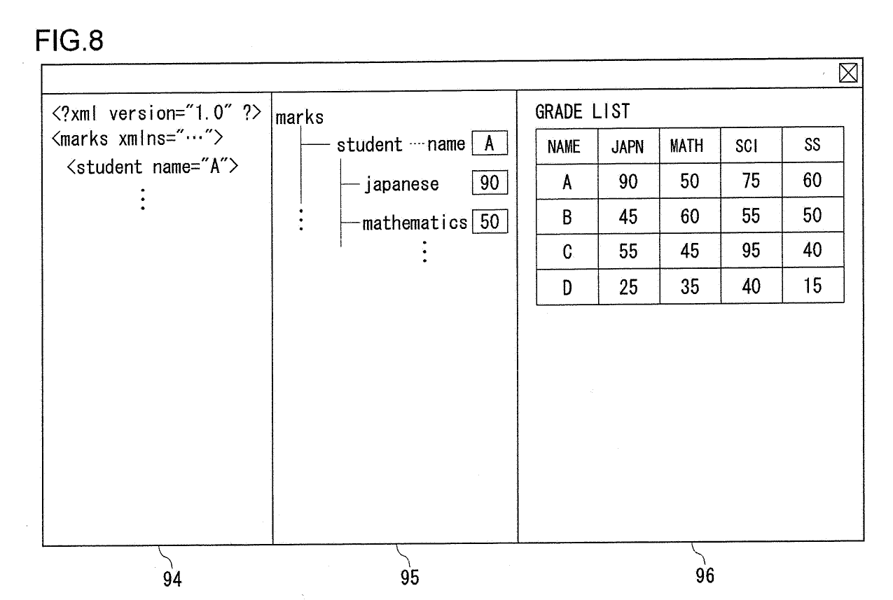

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event (s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

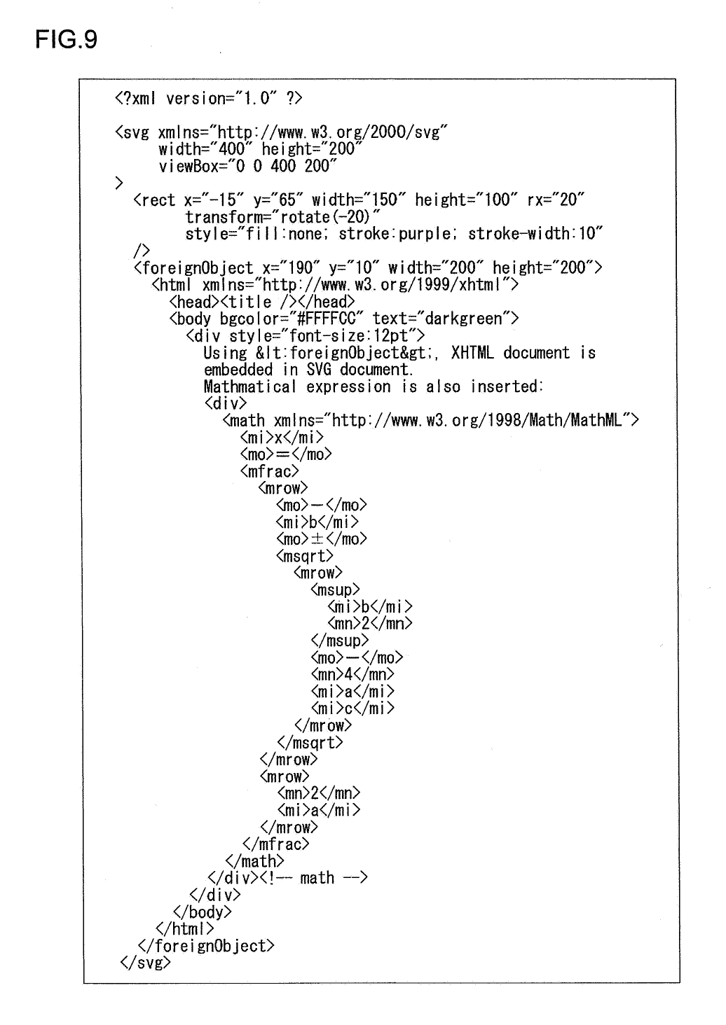

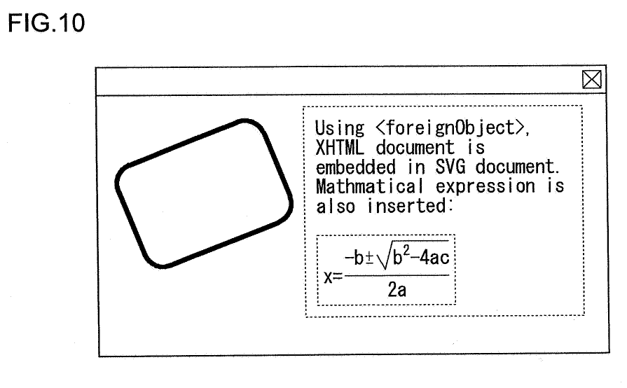

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the base technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

Then, further detailed description will be made regarding functions and components for providing the document processing 20 according to the base technology. In the following description, English terms are used for the class names and so forth.

### A. Outline

The advent of the Internet has resulted in a nearly exponential increase in the number of documents processed and managed by users. The Web (World Wide Web), which serves as the core of the Internet, provides a massive storage capacity for storing such document data. The Web also provides an information search system for such documents, in addition to the function of storing the documents. In general, such a document is described in a markup language. HTML (HyperText Markup Language) is an example of a popular basic markup language. Such a document includes links, each of which links the document to another document stored at another position on the Web. XML (eXtensible Markup Language) is a popular further improved markup language. Simple browsers which allow the user to access and browse such Web documents have been developed using object-oriented programming languages such as Java (trademark).

In general, documents described in markup languages are represented in a browser or other applications in the form of a tree data structure. This structure corresponds to a tree structure obtained as a result of parsing a document. The DOM (Document Object Model) is a well-known tree-based data structure model, which is used for representing and processing a document. The DOM provides a standard object set for representing documents, examples of which include an HTML document, an XML document, etc. The DOM includes two basic components, i.e., a standard model which shows how the objects that represent the respective components included in a document are connected to one another, and a standard interface which allows the user to access and operate each object.

Application developers can support the DOM as an interface for handling their own data structure and API (Application Program Interface). On the other hand, application providers who create documents can use the standard interface of the DOM, instead of using the DOM as an interface for handling their own API. The capacity of the DOM to provide such a standard interface has been effective in promoting document sharing in various environments, particularly on the Web. Several versions of the DOM have been defined, which are used in different environments and applications.

A DOM tree is a hierarchical representation of the structure of a document, which is based upon the content of a corresponding DOM. A DOM tree includes a “root”, and one or more “Nodes” branching from the root. In some cases, an entire document is represented by a root alone. An intermediate Node can represent an element such as a table, or a row or a column of the table, for example. A “leaf” of a DOM tree generally represents data which cannot be further parsed, such as text data, image data, etc. Each of the Nodes of the DOM tree may be associated with an attribute that specifies a parameter of the element represented by the Node, such as a font, size, color, indent, etc.

HTML is a language which is generally used for creating a document. However, HTML is a language that provides formatting and layout capabilities, and it is not meant to be used as a data description language. The Node of the DOM tree for representing an HTML document is defined beforehand as an HTML formatting tag, and in general, HTML does not provide detailed data description and data tagging/labeling functions. This leads to a difficulty in providing a query format for the data included in an HTML document.

The goal of network designers is to provide a software application which allows the user to make a query for and to process a document provided on the Web. Such a software application should allow the user to make a query for and to process a document, regardless of the display method, as long as the document is described in a hierarchically structured language. A markup language such as XML (eXtensible Markup Language) provides such functions.

Unlike HTML, XML has a well-known advantage of allowing the document designer to label each data element using a tag which can be defined by the document designer as desired. Such data elements can form a hierarchical structure. Furthermore, an XML document can include a document type definition that specifies a “grammar” which specifies the tags used in the document and the relations between the tags. Also, in order to define the display method of such a structured XML document, CSS (Cascading Style Sheets) or XSL (XML Style Language) is used. Additional information with respect to the features of the DOM, HTML, XML, CSS, XSL, and the related languages can be acquired via the Web, for example, from “http://www.w3.org/TR/”.

XPath provides common syntax and semantics which allow the position of a portion of an XML document to be specified. Examples of such functions include a function of traversing a DOM tree that corresponds to an XML document. This provides basic functions for operating character strings, values, and Boolean variables, which are related to the function of displaying an XML document in various manners. XPath does not provide a syntax for how the XML document is displayed, e.g., a grammar which handles a document in the form of text in increments of lines or characters. Instead of such a syntax, XPath handles a document in the form of an abstract and logical structure. The use of XPath allows the user to specify a position in an XML document via the hierarchical structure of a DOM tree of the XML document, for example. Also, XPath has been designed so as to allow the user to test whether or not the Nodes included in a DOM tree match a given pattern. Detailed description of XPath can be obtained from http://www.w3.org/TR/xpath.

There is a demand for an effective document processing system based upon the known features and advantages of XML, which provides a user-friendly interface which handles a document described in a markup language (e.g., XML), and which allows the user to create and modify such a document.

Some of the system components as described here will be described in a well-known GUI (Graphical User Interface) paradigm which is called the MVC (Model-View-Controller) paradigm. The MVC paradigm divides a part of an application or an interface of an application into three parts, i.e., “model”, “view”, and “controller”. In the GUI field, the MVC paradigm has been developed primarily for assigning the roles of “input”, “processing”, and “output”.

[input] R [processing] R [output]
[controller] R [model] R [view]

The MVC paradigm separately handles modeling of external data, visual feedback for the user, and input from the user, using a model object (M), a view object (V), and a controller object (C). The controller object analyzes the input from the user input via a mouse and a keyboard, and maps such user actions to a command to be transmitted to the model object and/or the view object. The model object operates so as to manage one or more data elements. Furthermore, the model object makes a response to a query with respect to the state of the data elements, and operates in response to an instruction to change the state of the data elements. The view object has a function of presenting data to the user in the form of a combination of graphics and text.

### B. Overall Configuration of the Document Processing System

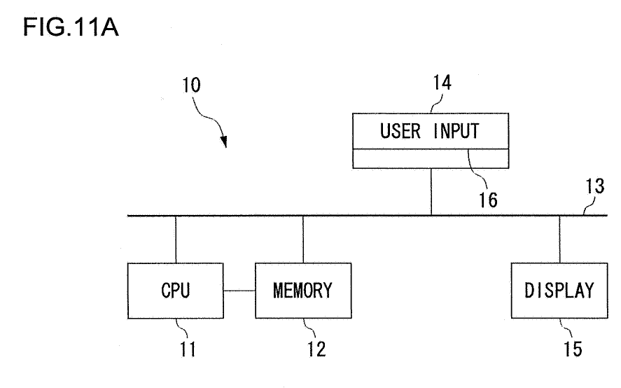

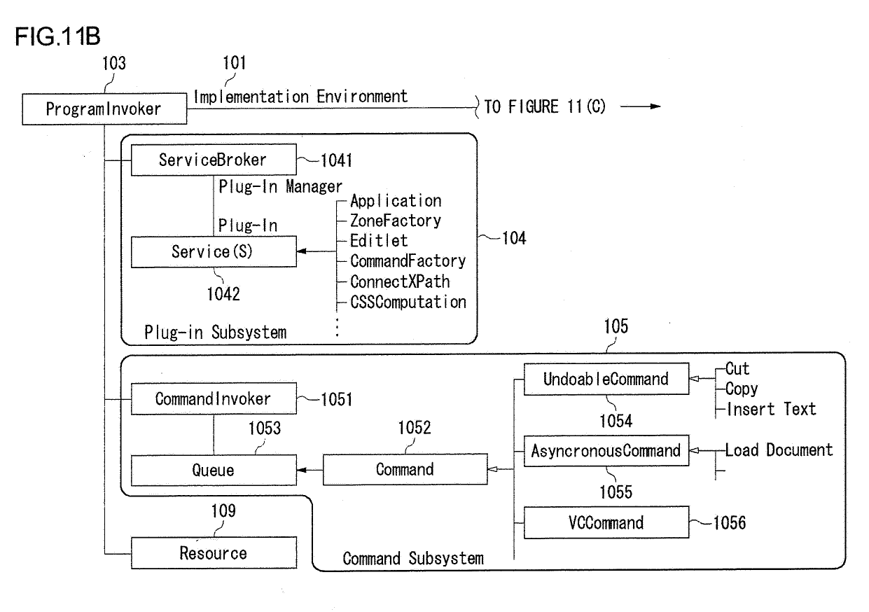

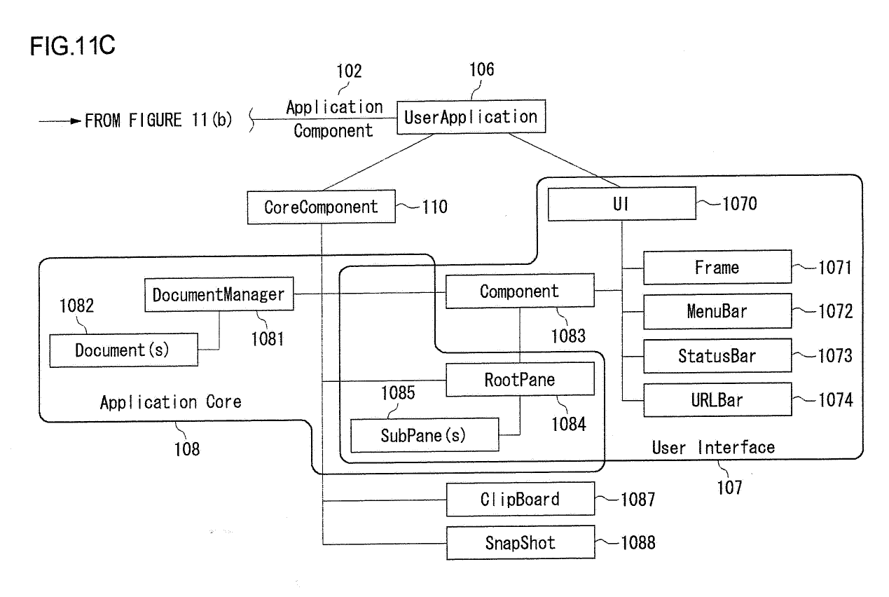

In order to make clear an embodiment of the document processing system, description will be made with reference to FIGS. 11 through 29.

FIG. 11(a) shows an example of a configuration comprising components that provide the basic functions of a kind of document processing system according to a conventional technique as will be mentioned later. A configuration 10 includes a processor in the form of a CPU or a microprocessor 11 connected to memory 12 via a communication path 13. The memory 12 may be provided in the form of any kind of ROM and/or RAM that is currently available or that may be available in the future. In a typical case, the communication path 13 is provided in the form of a bus. An input/output interface 16 for user input devices 14 such as a mouse, a keyboard, a speech recognition system, etc., and a display device 15 (or other user interfaces) is connected to the bus that provides communication with the processor 11 and the memory 12. Such a configuration may be provided in the form of a standalone device. Also, such a configuration may be provided in the form of a network which includes multiple terminals and one or more servers connected to one another. Also, such a configuration may be provided in any known form. The present invention is not restricted to a particular layout of the components, a particular architecture, e.g., a centralized architecture or a distributed architecture, or a particular one of various methods of communication between the components.

Furthermore, description will be made below regarding the present system and the embodiment regarding an arrangement including several components and sub-components that provide various functions. In order to provide desired functions, the components and the sub-components can be realized by hardware alone, or by software alone, in addition to various combinations of hardware and software. Furthermore, the hardware, the software, and the various combinations thereof can be realized by general purpose hardware, dedicated hardware, or various combinations of general purpose and dedicated hardware. Accordingly, the configuration of the component or the sub-component includes a general purpose or dedicated computation device for executing predetermined software that provides a function required for the component or the sub-component.

FIG. 11(b) is a block diagram which shows an overall configuration of an example of the document processing system. Such a document processing system allows a document to be created and edited. Such a document may be described in a desired language that has the functions required of a markup language, such as XML etc. Note that some terms and titles will be defined here for convenience of explanation. However, the general scope of the disclosure according to the present invention is not intended to be restricted by such terms and titles thus defined here.

The document processing system can be classified into two basic configurations. A first configuration is an “execution environment” 101 which provides an environment that allows the document processing system to operate. For example, the execution environment provides basic utilities and functions that support both the system and the user during the processing and management of a document. A second configuration is an “application” 102 that comprises applications that run under an execution environment. These applications include the documents themselves and various representations of the documents.

### 1. Execution Environment

The key component of the execution environment 101 is the ProgramInvoker (program invoking unit) 103. The ProgramInvoker 103 is a basic program, which is accessed in order to start up the document processing system. For example, upon the user logging on and starting up the document processing system, the ProgramInvoker 103 is executed. The ProgramInvoker 103 has: a function of reading out and executing a function added to the document processing system in the form of a plug-in; a function of starting up and executing an application; and a function of reading out the properties related to a document, for example. However, the functions of the ProgramInvoker 103 are not restricted to these functions. Upon the user giving an instruction to start up an application to be executed under the execution environment, the ProgramInvoker 103 finds and starts up the application, thereby executing the application.

Also, several components are attached to the ProgramInvoker 103, examples of which include a plug-in sub-system 104, a command sub-system 105, and a resource module 109. Detailed description will be made below regarding the configurations of such components.

### a) Plug-in Sub-System

The plug-in sub-system is used as a highly flexible and efficient configuration which allows an additional function to be added to the document processing system. Also, the plug-in sub-system 104 can be used for modifying or deleting functions included in the document processing system. Also, various kinds of functions can be added or modified using the plug-in sub-system. For example, the plug-in sub-system 104 allows an Editlet (editing unit) to be added, which supports functions of allowing the user to edit via the screen. Also, the Editlet plug-in supports the functions of allowing the user to edit a vocabulary added to the system.

The plug-in sub-system 104 includes a ServiceBroker (service broker unit) 1041. The ServiceBroker 1041 manages a plug-in added to the document processing system, thereby mediating between the service thus added and the document processing system.

Each of the desired functions is added in the form of a Service 1042. Examples of the available types of Services 1042 include: an Application Service; a ZoneFactory (zone creating unit) Service; an Editlet (editing unit) Service; a CommandFactory (command creating unit) Service; a ConnectXPath (XPath management unit) Service; a CSSComputation (CSS calculation unit) Service; etc. However, the Service 1042 is not restricted to such services. Detailed description will be made below regarding these Services, and regarding the relation between these Services and other components of the system, in order to facilitate understanding of the document processing system.

Description will be made below regarding the relation between a plug-in and a Service. The plug-in is a unit capable of including one or more ServiceProviders (service providing units). Each ServiceProvider has one or more classes for corresponding Services. For example, upon using a plug-in having an appropriate software application, one or more Services are added to the system, thereby adding the corresponding functions to the system.

### b) Command Sub-System

The command sub-system 105 is used for executing a command relating to the processing of a document. The command sub-system 105 allows the user to execute the processing of the document by executing a series of commands. For example, the command sub-system 105 allows the user to edit an XML DOM tree that corresponds to an XML document stored in the document processing system, and to process the XML document, by issuing a command. These commands may be input by key-strokes, mouse-clicks, or actions via other valid user interfaces. In some cases, when a single command is input, one or more sub-commands are executed. In such a case, these sub-commands are wrapped in a single command, and the sub-commands are consecutively executed. For example, let us consider a case in which the user has given an instruction to replace an incorrect word with a correct word. In this case, a first sub-command is an instruction to detect an incorrect word in the document. Then, a second sub-command is an instruction to delete the incorrect word. Finally, a third function is an instruction to insert a correct word. These three sub-commands may be wrapped in a single command.

Each command may have a corresponding function, e.g., an “undo” function described later in detail. Such a function may also be assigned to several basic classes used for creating an object.

The key component of the command sub-system 105 is a CommandInvoker (command invoking unit) 1051 which operates so as to allow the user to selectively input and execute the commands. FIG. 11(b) shows an arrangement having a single CommandInvoker. Also, one or more CommandInvokers may be used. Also, one or more commands may be executed at the same time. The CommandInvoker 1051 holds the functions and classes required for executing the command. In the operation, the Command 1052 is loaded in a Queue 1053. Then, the CommandInvoker 1051 creates a command thread for executing the commands in sequence. In a case that no Command is currently being executed by the CommandInvoker, the Command 1052 provided to be executed by the CommandInvoker 1051 is executed. In a case that a command is currently being executed by the CommandInvoker, the new Command is placed at the end of the Queue 1053. However, each CommandInvoker 1051 executes only a single command at a time. In a case of failure in executing the Command thus specified, the CommandInvoker 1051 performs exception handling.

Examples of the types of Commands executed by the CommandInvoker 1051 include: an UndoableCommand (undoable command) 1054; an AsynchronousCommand (asynchronous command) 1055; and a VCCommand (VC command) 1056. However, the types of commands are not restricted to those examples. The UndoableCommand 1054 is a command which can be undone according to an instruction from the user. Examples of UndoableCommands include a deletion command, a copy command, a text insertion command, etc. Let us consider a case in which, in the course of operation, the user has selected a part of a document, following which the deletion command is applied to the part thus selected. In this case, the corresponding UndoableCommand allows the deleted part to be restored to the state that it was in before the part was deleted.

The VCCommand 1056 is stored in a Vocabulary Connection Descriptor (VCD) script file. The VCCommand 1056 is a user specified Command defined by a programmer. Such a Command may be a combination of more abstract Commands, e.g., a Command for adding an XML fragment, a Command for deleting an XML fragment, a Command for setting an attribute, etc. In particular, such Commands are provided with document editing in mind.

The AsynchronousCommand 1055 is a command primarily provided for the system, such as a command for loading a document, a command for storing a document, etc. AsynchronousCommands 1055 are executed in an asynchronous manner, independently of UndoableCommands and VCCommands. Note that the AsynchronousCommand does not belong to the class of undoable commands (it is not an UndoableCommand). Accordingly, an AsynchronousCommand cannot be undone.

### c) Resource

The Resource 109 is an object that provides several functions to various classes. Examples of such system Resources include string resources, icon resources, and default key bind resources.

### 2. Application Component

The application component 102, which is the second principal component of the document processing system, is executed under the execution environment 101. The application component 102 includes actual documents and various kinds of logical and physical representations of the documents included in the system. Furthermore, the application component 102 includes the configuration of the system used for management of the documents. The application component 102 further includes a UserApplication (user application) 106, an application core 108, a user interface 107, and a CoreComponent (core component) 110.

### a) User Application

The UserApplication 106 is loaded in the system along with the ProgramInvoker 103. The UserApplication 106 serves as a binding agent that connects a document, the various representations of the document, and the user interface required for communicating with the document. For example, let us consider a case in which the user creates a document set which is a part of a project. Upon loading the document set, an appropriate representation of the document is created. The user interface function is added as a part of the UserApplication 106. In other words, with regard to a document that forms a part of a project, the UserApplication 106 holds both the representation of the document that allows the user to communicate with the document, and various other document conditions. Once the UserApplication 106 has been created, such an arrangement allows the user to load the UserApplication 106 under the execution environment in a simple manner every time there is a need to communicate with a document that forms a part of a project.

### b) Core Component

The CoreComponent 110 provides a method which allows a document to be shared over multiple panes. As described later in detail, the Pane displays a DOM tree, and provides a physical screen layout. For example, a physical screen is formed of multiple Panes within a screen, each of which displays a corresponding part of the information. With such an arrangement, a document displayed on the screen for the user can be displayed in one or more Panes. Also, two different documents may be displayed on the screen in two different Panes.

As shown in FIG. 11(c), the physical layout of the screen is provided in a tree form. The Pane can be a RootPane (root pane) 1084. Also, the Pane can be a SubPane (sub-pane) 1085. The RootPane 1084 is a Pane which is positioned at the root of a Pane tree. The SubPanes 1085 are other Panes that are distinct from the RootPane 1084.

The CoreComponent 110 provides a font, and serves as a source that provides multiple functional operations for a document. Examples of the tasks executed by the CoreComponent 110 include movement of a mouse cursor across the multiple Panes. Other examples of the tasks thus executed include a task whereby a part of the document displayed on a Pane is marked, and the part thus selected is duplicated on another Pane.

### c) Application Core

As described above, the application component 102 has a structure that comprises documents to be processed and managed by the system. Furthermore, the application component 102 includes various kinds of logical and physical representations of the documents stored in the system. The application core 108 is a component of the application component 102. The application core 108 provides a function of holding an actual document along with all the data sets included in the document. The application core 108 includes a DocumentManager (document manager, document managing unit) 1081 and a Document (document) 1082 itself.

Detailed description will be made regarding various embodiments of the DocumentManager 1081. The DocumentManager 1081 manages the Document 1082. The DocumentManager 1081 is connected to the RootPane 1085, the SubPane 1085, a ClipBoard (clipboard) utility 1087, and a SnapShot (snapshot) utility 1088. The ClipBoard utility 1087 provides a method for holding a part of the document which is selected by the user as a part to be added to the clipboard. For example, let us consider a case in which the user deletes a part of a document, and stores the part thus deleted in a new document as a reference document. In this case, the part thus deleted is added to the ClipBoard.

Next, description will also be made regarding the SnapShot utility 1088. The SnapShot utility 1088 allows the system to store the current state of an application before the state of the application changes from one particular state to another state.

### d) User Interface

The user interface 107 is another component of the application component 102, which provides a method that allows the user to physically communicate with the system. Specifically, the user interface allows the user to upload, delete, edit, and manage a document. The user interface includes a Frame (frame) 1071, a MenuBar (menu bar) 1072, a StatusBar (status bar) 1073, and a URLBar (URL bar) 1074.

The Frame 1071 serves as an active region of a physical screen, as is generally known. The Menubar 1072 is a screen region including a menu that provides selections to the user. The StatusBar 1073 is a screen region that displays the status of the application which is being executed. The URLBar 1074 provides a region which allows the user to input a URL address for Internet navigation.

### C. Document Management and Corresponding Data Structure

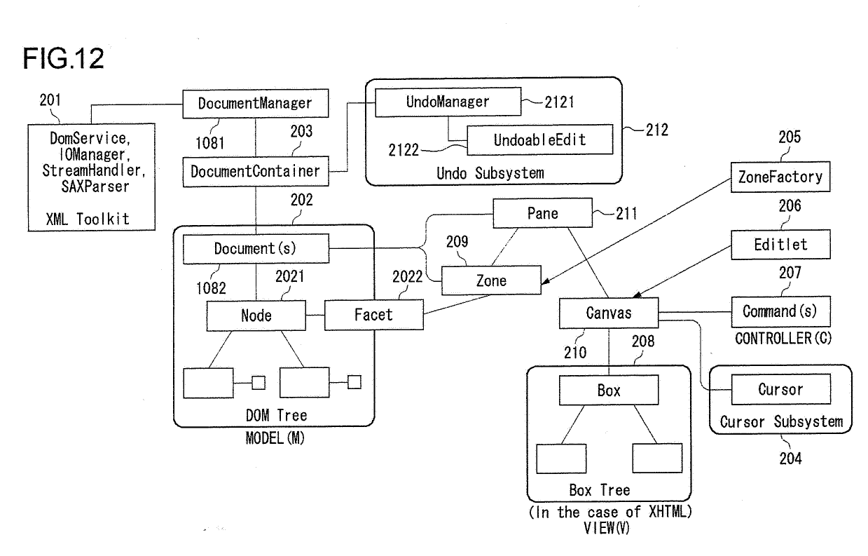

FIG. 12 shows a configuration of the DocumentManager 1081 in detail. The DocumentManager 1081 includes a data structure and components used for representing a document in the document processing system. Description will be made regarding such components in this sub-section using the MVC paradigm for convenience of explanation.

The DocumentManager 1081 includes a DocumentContainer (document container) 203 which holds all the documents stored in the document processing system, and which serves as a host machine. A tool kit 201 attached to the DocumentManager 1081 provides various tools used by the DocumentManager 1081. For example, the tool kit 201 provides a DomService (DOM service) which provides all the functions required for creating, holding, and managing a DOM that corresponds to a document. Also, the tool kit 201 provides an IOManager (input/output management unit) which is another tool for managing the input to/output from the system. Also, a StreamHandler (stream handler) is a tool for handling uploading a document in the form of a bit stream. The tool kit 201 includes such tools in the form of components, which are not shown in the drawings in particular, and are not denoted by reference numerals.

With the system represented using the MVC paradigm, the model (M) includes a DOM tree model 202 of a document. As described above, each of all the documents is represented by the document processing system in the form of a DOM tree. Also, the document forms a part of the DocumentContainer 203.

### 1. DOM Model and Zone

The DOM tree which represents a document has a tree structure having Nodes (Nodes) 2021. A Zone (zone) 209, which is a subset of the DOM tree, includes a region that corresponds to one or more Nodes within the DOM tree. For example, a unit of a document can be displayed on a screen. In this case, the part of the document that is visually output is displayed using the Zone 209. The Zone is created, handled, and processed using a plug-in which is so-called ZoneFactory (Zone Factory=Zone creating part) 205. While the Zone represents a part of the DOM, the Zone can use one or more “namespaces”. It is well known that a namespace is a set that consists of unique names, each of which differs from every other name in the namespace. In other words, the namespace does not include the same names repeated.

### 2. Facets and the Relation Between Facets and Zones

A Facet 2022 is another component included in the model (M) component of the MVC paradigm. The Facet is used for editing the Node in the Zone. The Facet 2022 allows the user to access the DOM using a procedure that can be executed without affecting the content of the Zone. As described below, such a procedure executes an important and useful operation with respect to the Node.

Each Node has a corresponding Facet. With such an arrangement, the facet is used for executing the operation instead of directly operating the Node in the DOM, thereby maintaining the integrity of the DOM. On the other hand, let us consider an arrangement in which an operation is performed directly on the Node. With such an arrangement, multiple plug-ins can change the DOM at the same time, leading to a problem that the integrity of the DOM cannot be maintained.

The DOM standard stipulated by the World Wide Web Consortium (W3C) defines a standard interface for operating a Node. In practice, unique operations particular to each vocabulary or each Node are required. Accordingly, such unique operations are preferably provided in the form of an API. The document processing system provides such an API particular to each Node in the form of a Facet which is attached to the Node. Such an arrangement allows a useful API to be attached to the DOM according to the DOM standard. Furthermore, with such an arrangement, after a standard DOM has been installed, unique APIs are attached to the DOM, instead of installing a unique DOM for each vocabulary. This allows various types of vocabularies to be uniformly handled. Furthermore, such an arrangement allows the user to properly process a document described using a desired combination of multiple vocabularies.

Each vocabulary is a set of tags (e.g., XML tags), which belong to a corresponding namespace. As described above, each namespace has a set of unique names (in this case, tags) Each vocabulary is handled as a sub-tree of the DOM tree which represents an XML document. The sub-tree includes the Zone. In particular cases, the boundary between the tag sets is defined by the Zone. The Zone 209 is created using a Service which is called a ZoneFactory 205. As described above, the Zone 209 is an internal representation of a part of the DOM tree which represents a document. In order to provide a method that allows the user to access a part of such a document, the system requires a logical representation of the DOM tree. The logical representation of the DOM allows the computer to be informed of how the document is logically represented on a screen. A Canvas (canvas) 210 is a Service that operates so as to provide a logical layout that corresponds to the Zone.

On the other hand, a Pane 211 is a physical screen layout that corresponds to a logical layout provided by the Canvas 210. In practice, the user views only a rendering of the document, through text or images displayed on a screen. Accordingly, there is a need to use a process for drawing text and images on a screen to display the document on a screen. With such an arrangement, the document is displayed on a screen by the Canvas 210 based upon the physical layout provided from the Pane 211.

The Canvas 210 that corresponds to the Zone 209 is created using an Editlet 206. The DOM of the document is edited using the Editlet 206 and the Canvas 210. In order to maintain the integrity of the original document, the Editlet 206 and the Canvas 210 use the Facet that corresponds to one or more Nodes included in the Zone 209. The Facet is operated using a Command 207.

In general, the user communicates with a screen by moving a cursor on a screen or typing a command. The Canvas 210, which provides a logical layout on a screen, allows the user to input such cursor operations. The Canvas 210 instructs the Facet to execute a corresponding action. With such a relation, the cursor sub-system 204 serves as a controller (C) according to the MVC paradigm with respect to the DocumentManager 1081. The Canvas 210 also provides a task for handling an event. Examples of such events handled by the canvas 210 include: a mouse click event; a focus movement event; and a similar action event occurring in response to the user operation.

### 3. Outline of the Relation Between Zone, Facet, Canvas, and Pane

The document in the document processing system can be described from at least four points of view. That is to say, it can be seen as: 1) a data structure for maintaining the content and structure of a document in the document processing system, 2) means by which the user can edit the content of the document while maintaining the integrity of the document, 3) a logical layout of the document on a screen, and 4) a physical layout of the document on the screen. The components of the document processing system that correspond to the aforementioned four points of view are the Zone, Facet, Canvas, and Pane, respectively.

### 4. Undo Sub-System

As described above, all modifications made to the document (e.g., document editing procedures) are preferably undoable. For example, let us consider a case in which the user executes an editing operation, and then determines that the modification thus made to the document should be undone. Referring to FIG. 12, the undo subsystem 212 provides an undo component of a document management unit. With such an arrangement, an UndoManager (undo manager=undo management unit) 2121 holds all the undoable operations for the document which the user can select to be undone.

Let us consider a case in which the user executes a command for replacing a word in a document by another word, following which the user determines that, on reflection, the replacement of the word thus effected should be undone. The undo sub-system supports such an operation. The UndoManager 2121 holds such an operation of an UndoableEdit (undoable edit) 2122.

### 5. Cursor Sub-System

As described above, the controller unit of the MVC may include the cursor sub-system 204. The cursor sub-system 204 receives the input from the user. In general, such an input provides command input and/or edit operation. Accordingly, with respect to the DocumentManager 1081, the cursor sub-system 204 serves as the controller (C) component according to the MVC paradigm.

### 6. View

As described above, the Canvas 210 represents the logical layout of a document to be displayed on a screen. In a case that the document is an XHTML document, the Canvas 210 may include a box tree 208 that provides a logical representation of a document, which indicates how the document is displayed on a screen. With respect to the DocumentManager 1081, the box tree 208 may be included in the view (V) component according to the MVC paradigm.

### D. Vocabulary Connection

The important feature of the document processing system is that the document processing system provides an environment which allows the user to handle an XML document via other representations to which the document has been mapped. With such an environment, upon the user editing a representation to which the source XML document has been mapped, the source XML document is modified according to the edit operation while maintaining the integrity of the XML document.

A document described in a markup language, e.g., an XML document is created based upon a vocabulary defined by a document type definition. The vocabulary is a set of tags. The vocabulary can be defined as desired. This allows a limitless number of vocabularies to be created. It does not serve any practical purpose to provide dedicated viewer/editor environments for such a limitless number of vocabularies. The vocabulary connection provides a method for solving this problem.

For example, a document can be described in two or more markup languages. Specific examples of such markup languages used for describing a document include: XHTML (extensible HyperText Markup Language), SVG (Scalable Vector Graphics), MathML (Mathematical Markup Language), and other markup languages. In other words, such a markup language can be handled in the same way as is the vocabulary or the tag set in XML.

A vocabulary is processed using a vocabulary plug-in. In a case that the document has been described in a vocabulary for which there is no available plug-in in the document processing system, the document is mapped to a document described in another vocabulary for which a plug-in is available, thereby displaying the document. Such a function enables a document to be properly displayed even if the document has been described in a vocabulary for which there is no available plug-in.

The vocabulary connection has a function of acquiring a definition file, and a function of mapping from one vocabulary to another different vocabulary based upon the definition file thus acquired. With such an arrangement, a document described in one vocabulary can be mapped to a document described in another vocabulary. As described above, the vocabulary connection maps a document described in one vocabulary to another document described in another vocabulary for which there is a corresponding display/editing plug-in, thereby allowing the user to display and edit the document.

As described above, in general, each document is described by the document processing system in the form of a DOM tree having multiple Nodes. The “definition file” describes the relations among the different Nodes. Furthermore, the definition file specifies whether or not the element values and the attribute values can be edited for each Node. Also, the definition file may specify an expression using the element values and the attribute values of the Nodes.

Using the mapping function by applying the definition file, a destination DOM tree can be created. As described above, the relation between the source DOM tree and the destination DOM tree is created and held. The vocabulary connection monitors the relation between the source DOM tree and the destination DOM tree. Upon reception of an editing instruction from the user, the vocabulary connection modifies the corresponding Node included in the source DOM tree. Subsequently, a “mutation event” is issued, which gives notice that the source DOM tree has been modified. Then, the destination DOM tree is modified in response to the mutation event.

The use of the vocabulary connection allows a relatively minor vocabulary used by a small number of users to be converted into another major vocabulary. Thus, such an arrangement provides a desirable editing environment, which allows a document to be properly displayed even if the document is described in a minor vocabulary used by a small number of users.

As described above, the vocabulary connection sub-system which is a part of the document processing system provides a function that allows a document to be represented in multiple different ways.

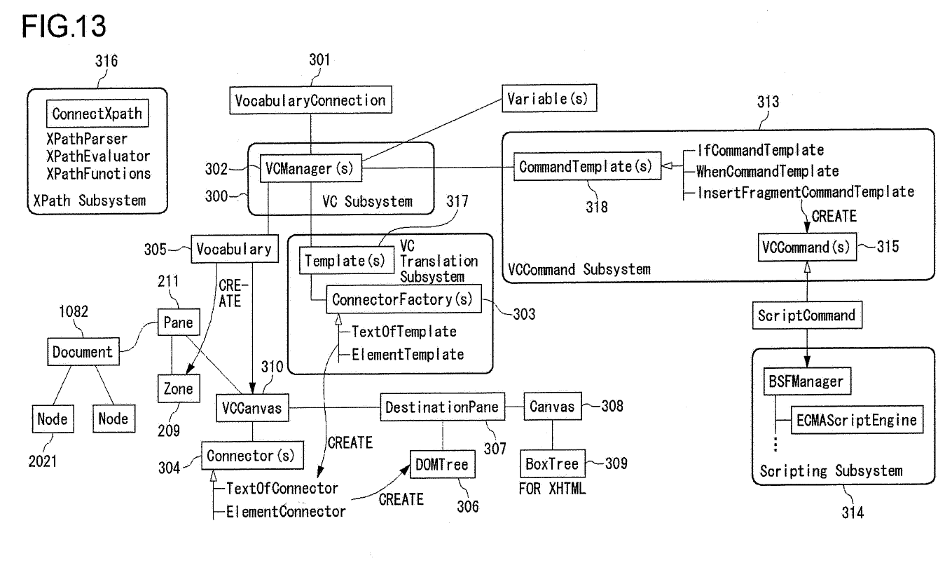

FIG. 13 shows a vocabulary connection (VC) sub-system 300. The VC sub-system 300 provides a method for representing a document in two different ways while maintaining the integrity of the source document. For example, a single document may be represented in two different ways using two different vocabularies. Also, one representation may be a source DOM tree, and the other representation may be a destination DOM tree, as described above.

### 1. Vocabulary Connection Sub-System

The functions of the vocabulary connection sub-system 300 are provided to the document processing system using a plug-in which is called a VocabularyConnection 301. With such an arrangement, a corresponding plug-in is requested for each Vocabulary 305 used for representing the document. For example, let us consider a case in which a part of the document is described in HTML, and the other part is described in SVG. In this case, the vocabulary plug-in that corresponds to HTML and the vocabulary plug-in that corresponds to SVG are requested.

The VocabularyConnection plug-in 301 creates a proper VCCanvas (vocabulary connection canvas) 310 that corresponds to a document described in a properVocabulary 305 for the Zone 209 or the Pane 211. Using the VocabularyConnection 301, a modification made to the Zone 209 within the source DOM tree is transmitted to the corresponding Zone within another DOM tree 306 according to a conversion rule. The conversion rule is described in the form of a vocabulary connection descriptor (VCD) Furthermore, a corresponding VCManager (vocabulary connection manager) 302 is created for each VCD file that corresponds to such a conversion between the source DOM and the destination DOM.

### 2. Connector

A Connector 304 connects the source Node included within the source DOM tree and the destination Node included within the destination DOM tree. The Connector 304 operates so as to monitor modifications (changes) made to the source Node included within the source DOM tree and the source document that corresponds to the source Node. Then, the Connector 304 modifies the corresponding Node of the destination DOM tree. With such an arrangement, the Connector 304 is the only object which is capable of modifying the destination DOM tree. Specifically, the user can modify only the source document and the corresponding source DOM tree. With such an arrangement, the Connector 304 modifies the destination DOM tree according to the modification thus made by the user.

The Connectors 304 are logically linked to each other so as to form a tree structure. The tree structure formed of the Connectors 304 is referred to as a ConnectorTree (connector tree).

The connector 304 is created using a Service which is called a ConnectorFactory (connector factory=connector generating unit) 303. The ConnectorFactory 303 creates the Connectors 304 based upon a source document, and links the Connectors 304 to each other so as to create a ConnectorTree. The VocabularyConnectionManager 302 holds the ConnectorFactory 303.

As described above, a vocabulary is a set of tags for a namespace. As shown in the drawing, the VocabularyConnection 301 creates the Vocabulary 305 for a document. Specifically, the Vocabulary 305 is created by analyzing the document file, and then creating a proper VocabularyConnectionManager 302 for mapping between the source DOM and the destination DOM. Furthermore, a proper relation is created between the ConnectorFactory 303 for creating the Connectors, the ZoneFactory 205 for creating the Zones 209, and the Editlet 206 for creating the Canvases. In a case that the user has discarded or deleted a document stored in the system, the corresponding VocabularyConnectionManager 302 is deleted.

The Vocabulary 305 creates the VCCanvas 310. Furthermore, the connectors 304 and the destination DOM tree 306 are created corresponding to the creation of the VCCanvas 310.

The source DOM and the Canvas correspond to the Model (M) and the View (V), respectively. However, such a representation is useful only in a case that the target vocabulary allows a document to be displayed on a screen. With such an arrangement, the display is performed by the vocabulary plug-in. Such a Vocabulary plug-in is provided for each of the principal vocabularies, e.g., XHTML, SVG, and MathML. Such a vocabulary plug-in is used for the target vocabulary. Such an arrangement provides a method for mapping a vocabulary to another vocabulary using a vocabulary connection descriptor.

Such mapping is useful only in a case that the target vocabulary can be mapped, and a method has been defined beforehand for displaying such a document thus mapped on a screen. Such a rendering method is defined in the form of a standard defined by an authority such as the W3C.

In a case that the processing requires vocabulary connection, the VCCanvas is used. In this case, the view for the source cannot be directly created, and accordingly, the Canvas for the source is not created. In this case, the VCCanvas is created using the ConnectorTree. The VCCanvas handles only the conversion of the event, but does not support display of the document on a screen.

### 3. DestinationZone, Pane, and Canvas

As described above, the purpose of the vocabulary connection sub-system is to create and hold two representations of a single document at the same time. With such an arrangement, the second representation is provided in the form of a DOM tree, which has been described as the destination DOM tree. The display of the document in the form of the second representation requires the DestinationZone, Canvas, and Pane.

When the VCCanvas is created, a corresponding DestinationPane 307 is also created. Furthermore, a corresponding DestinationCanvas 308 and a corresponding BoxTree 309 are created. Also, the VCCanvas 310 is associated with the Pane 211 and the Zone 209 for the source document.

The DestinationCanvas 308 provides a logical layout of a document in the form of the second representation. Specifically, the DestinationCanvas 308 provides user interface functions such as a cursor function and a selection function, for displaying a document in the form of a destination representation of the document. The event occurring at the DestinationCanvas 308 is supplied to the Connector. The DestinationCanvas 308 notifies the Connector 304 of the occurrence of a mouse event, a keyboard event, a drag-and-drop event, and events particular to the destination representation (second representation).

### 4. Vocabulary Connection Command Sub-System

The vocabulary connection (VC) sub-system 300 includes a vocabulary connection (VC) command sub-system 313 in the form of a component. The vocabulary connection command sub-system 313 creates a VCCommand (vocabulary connection command) 315 used for executing a command with respect to the vocabulary connection sub-system 300. The VCCommand can be created using a built-in CommandTemplate (command template) and/or created from scratch using a script language supported by a script sub-system 314.

Examples of such command templates include an “If” command template, “When” command template, “Insert” command template, etc. These templates are used for creating a VCCommand.

### 5. XPath Sub-System

An XPath sub-system 316 is an important component of the document processing system, and supports the vocabulary connection. In general, the Connector 304 includes XPath information. As described above, one of the tasks of the vocabulary connection is to modify the destination DOM tree according to the change in the source DOM tree. The XPath information includes one or more XPath representations used for determining a subset of the source DOM tree which is to be monitored to detect changes and/or modifications.

### 6. Outline of Source DOM Tree, Destination DOM Tree, and ConnectorTree

The source DOM tree is a DOM tree or a Zone of a document described in a vocabulary before vocabulary conversion. The source DOM tree Node is referred to as the source Node.

On the other hand, the destination DOM tree is a DOM tree or a Zone of the same document as that of the source DOM tree, and which is described in another vocabulary after having been converted by mapping, as described above in connection with the vocabulary connection. Here, the destination DOM tree Node is referred to as the destination Node.

The ConnectorTree is a hierarchical representation which is formed based upon the Connectors that represent the relation between the source Nodes and the destination Nodes. The Connectors monitor the source Node and the modifications applied to the source document, and modify the destination DOM tree. The Connector is the only object that is permitted to modify the destination DOM tree.

### E. Event Flow in the Document Processing System

In practice, the program needs to respond to the commands input from the user. The “event” concept provides a method for describing and executing the user action executed on a program. Many high-level languages, e.g., Java (trademark) require events, each of which describes a corresponding user action. On the other hand, conventional programs need to actively collect information for analyzing the user's actions, and for execution of the user's actions by the program itself. This means that, after initialization of the program, the program enters loop processing for monitoring the user's actions, which enables appropriate processing to be performed in response to any user action input by the user via the screen, keyboard, mouse, or the like. However, such a process is difficult to manage. Furthermore, such an arrangement requires a program which performs loop processing in order to wait for the user's actions, leading to a waste of CPU cycles.

Many languages employ distinctive paradigms in order to solve such problems. One of these paradigms is event-driven programming, which is employed as the basis of all current window-based systems. In this paradigm, all user actions belong to sets of abstract phenomena which are called “events”. An event provides a sufficiently detailed description of a corresponding user action. With such an arrangement, in a case that an event to be monitored has occurred, the system notifies the program to that effect, instead of an arrangement in which the program actively collects events occurring according to the user's actions. A program that communicates with the user using such a method is referred to as an “event-driven” program.

In many cases, such an arrangement handles an event using a “Event” class that acquires the basic properties of all the events which can occur according to the user's actions.

Before the use of the document processing system, the events for the document processing system itself and a method for handling such events are defined. With such an arrangement, several types of events are used. For example, a mouse event is an event that occurs according to the action performed by the user via a mouse. The user action involving the mouse is transmitted to the mouse event by the Canvas 210. As described above, it can be said that the Canvas is the foremost level of interaction between the user and the system. As necessary, this foremost Canvas level hands over the event content to the child levels.

On the other hand, a keystroke event is issued from the Canvas 210. The keystroke event acquires a real-time focus. That is to say, a keystroke event always involves an operation. The keystroke event input to the Canvas 210 is also transmitted to the parent of the Canvas 210. Key input actions are processed via other events that allow the user to insert a character string. The event for handling the insertion of a character string occurs according to the user action in which a character is input via the keyboard. Examples of “other events” include other events which are handled in the same way as a drag event, a drop event, and a mouse event.

### 1. Handling of an Event Outside of the Vocabulary Connection

An event is transmitted using an event thread. The state of the Canvas 210 is modified upon reception of an event. As necessary, the Canvas 210 posts the Command 1052 to the CommandQueue 1053.

2. Handling of an Event within the Vocabulary Connection

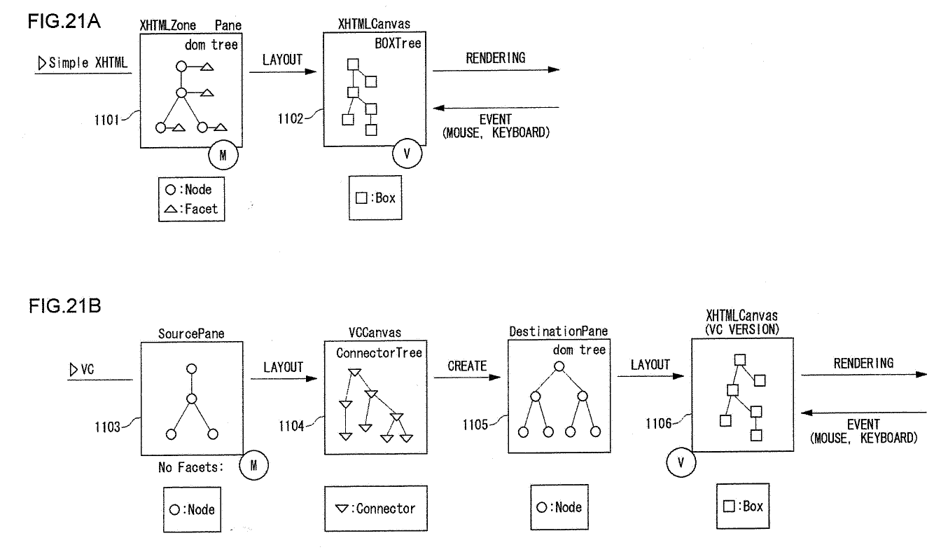

An XHTMLCanvas 1106, which is an example of the DestinationCanvas, receives events that occur, e.g., a mouse event, a keyboard event, a drag-and-drop event, and events particular to the vocabulary, using the VocabularyConnection plug-in 301. The connector 304 is notified of these events. More specifically, the event passes through a SourcePane 1103, a VCCanvas 1104, a DestinationPane 1105, a DestinationCanvas 1106 which is an example of the DestinationCanvas, a destination DOM tree, and a ConnectorTree, within the VocabularyConnection plug-in, as shown in FIG. 21(b).

### F. ProgramInvoker and the Relation Between ProgramInvoker and Other Components

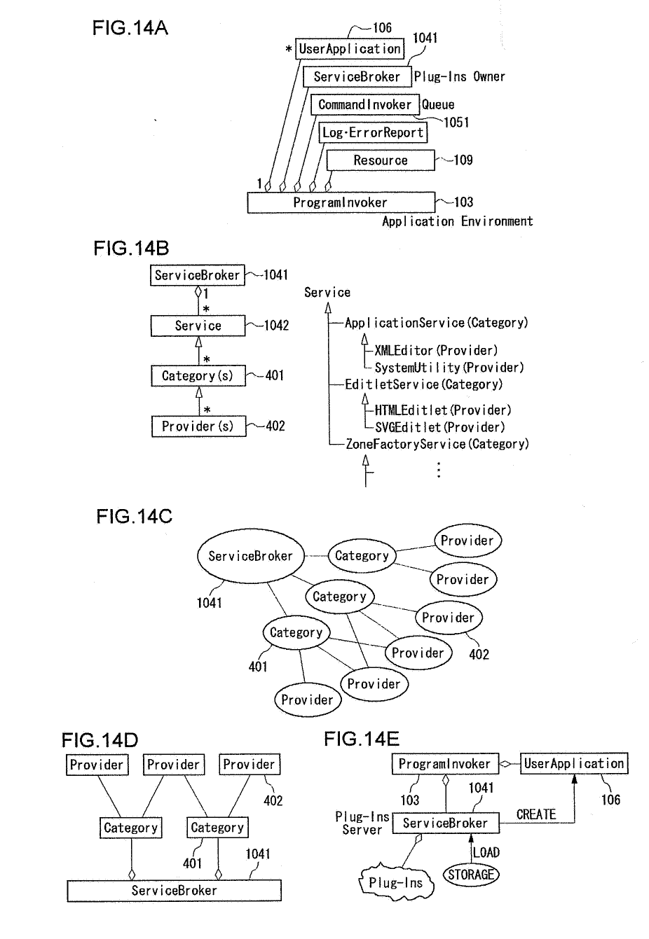

FIG. 14(a) shows the ProgramInvoker 103 and the relation between the ProgramInvoker 103 and other components in more detail. The ProgramInvoker 103 is a basic program executed under the execution environment, which starts up the document processing system. As shown in FIG. 11(b) and FIG. 11(c), the UserApplication 106, the ServiceBroker 1041, the CommandInvoker 1051, and the Resource 109 are each connected to the ProgramInvoker 103. As described above, the application 102 is a component executed under the execution environment. Also, the ServiceBroker 1041 manages the plug-ins, which provide various functions to the system. On the other hand, the CommandInvoker executes a command provided from the user, and holds the classes and functions for executing the command.

### 1. Plug-In and Service

A more detailed description will be made regarding the ServiceBroker 1041 with reference to FIG. 14(b). As described above, the ServiceBroker 1041 manages the plug-ins (and corresponding services), which allows various functions to be added to the system. The Service 1042 is the lowermost layer, having a function of adding the features to the document processing system, and a function of modifying the features of the document processing system. A “Service” consists of two parts, i.e., a part formed of ServiceCategories 401 and another part formed of ServiceProviders 402. As shown in FIG. 14(c), one ServiceCategory 401 may include multiple corresponding ServiceProviders 402. Each ServiceProvider operates a part of, or the entire functions of, the corresponding ServiceCategory. Also, the ServiceCategory 401 defines the type of Service.

The Services can be classified into three types, i.e., a “feature service” which provides predetermined features to the document processing system, an “application service” which is an application executed by the document processing system, and an “environment” service that provides the features necessary throughout the document processing system.

FIG. 14(d) shows an example of a Service. In this example, with respect to the Category of the application Service, the system utility corresponds to the ServiceProvider. In the same way, the Editlet 206 is the Category, and an HTMLEditlet and the SVGEditlet are the corresponding ServiceProviders. Also, the ZoneFactory 205 is another Service Category, and has a corresponding ServiceProvider (not shown).

As described above, a plug-in adds functions to the document processing system. Also, a plug-in can be handled as a unit that comprises several ServiceProviders 402 and the classes that correspond to the ServiceProviders 402. Each plug-in has dependency specified in the definition file and a ServiceCategory 401.

### 2. Relation Between the ProgramInvoker and the Application

FIG. 14(e) shows the relation between the ProgramInvoker 103 and the UserApplication 106 in more detail. The required documents and data are loaded from the storage. All the required plug-ins are loaded in the ServiceBroker 1041. The ServiceBroker 1041 holds and manages all the plug-ins. Each plug-in is physically added to the system. Also, the functions of the plug-in can be loaded from the storage. When the content of a plug-in is loaded, the ServiceBroker 1041 defines the corresponding plug-in. Subsequently, a corresponding UserApplication 106 is created, and the UserApplication 106 thus created is loaded in the execution environment 101, thereby attaching the plug-in to the ProgramInvoker 103.

### G. The Relation Between the Application Service and the Environment

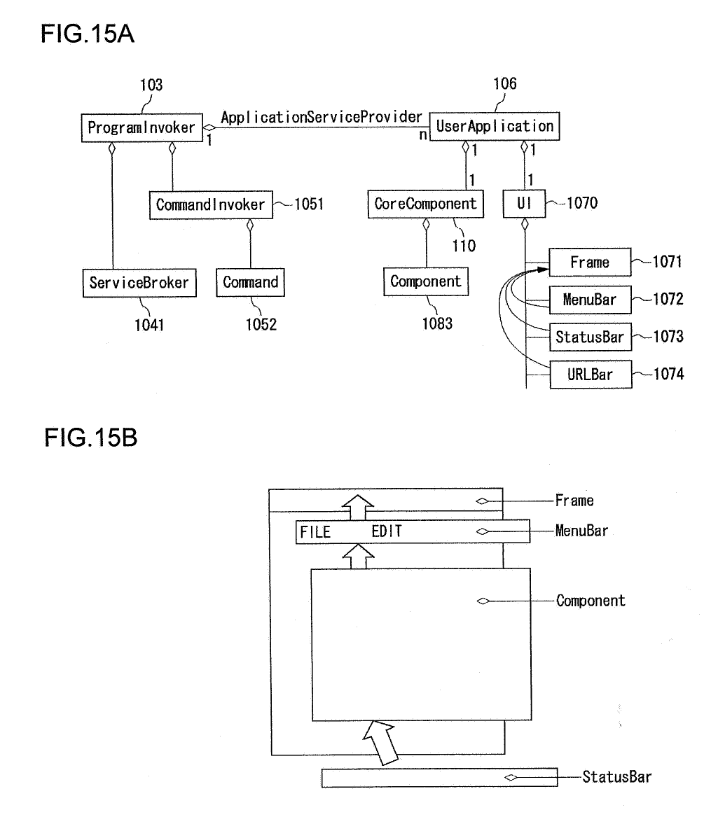

FIG. 15(a) shows the configuration of the application service loaded in the ProgramInvoker 103 in more detail. The CommandInvoker 1051, which is a component of the command sub-system 105, starts up or executes the Command 1052 in the ProgramInvoker 103. With such a document processing system, the Command 1052 is a command used for processing a document such as an XML document, and editing the corresponding XML DOM tree. The CommandInvoker 1051 holds the classes and functions required to execute the Command 1052.

Also, the ServiceBroker 1041 is executed within the ProgramInvoker 103. The UserApplication 106 is connected to the user interface 107 and the CoreComponent 110. The CoreComponent 110 provides a method which allows all the Panes to share a document. Furthermore, the CoreComponent 110 provides a font, and serves as a tool kit for the Pane.

FIG. 15(b) shows the relation between the Frame 1071, the MenuBar 1072, and the StatusBar 1073.

### H. Application Core

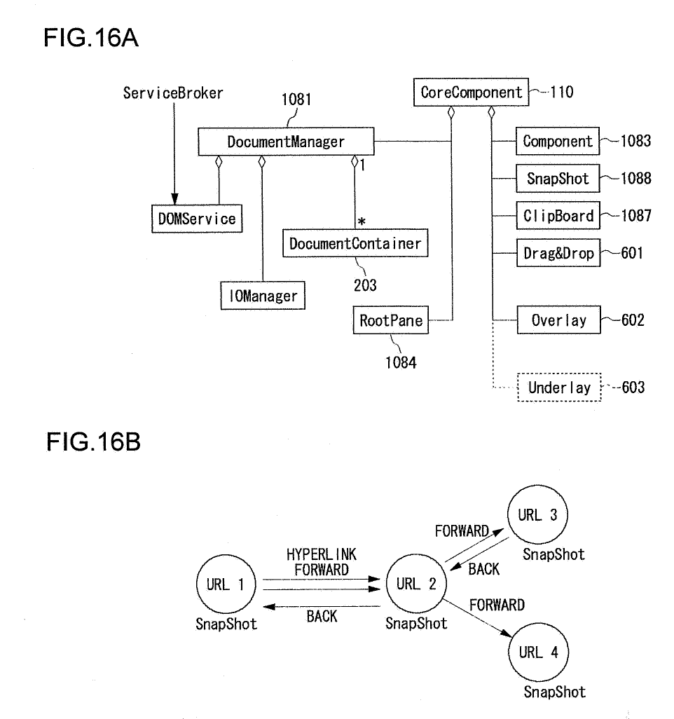

FIG. 16(a) provides a more detailed description of the application core 108, which holds the whole document, and a part of the document, and the data of the document. The CoreComponent 110 is attached to the DocumentManager 1081 for managing the documents 1082. The DocumentManager 1081 is the owner of all the documents 1082 stored in memory in association with the document processing system.

In order to display a document on a screen in a simple manner, the DocumentManager 1081 is also connected to the RootPane 1084. Also, the functions of the Clipboard 1087, a Drag&Drop 601, and an Overlay 602 are attached to the CoreComponent 110.

The SnapShot 1088 is used for restoring the application to a given state. Upon the user executing the SnapShot 1088, the current state of the application is detected and stored. Subsequently, when the application state changes, the content of the application state thus stored is maintained. FIG. 16(b) shows the operation of the SnapShot 1088. With such an arrangement, upon the application switching from one URL to another, the SnapShot 1088 stores the previous state. Such an arrangement allows operations to be performed forward and backward in a seamless manner.

### I. Document Structure Within the DocumentManager

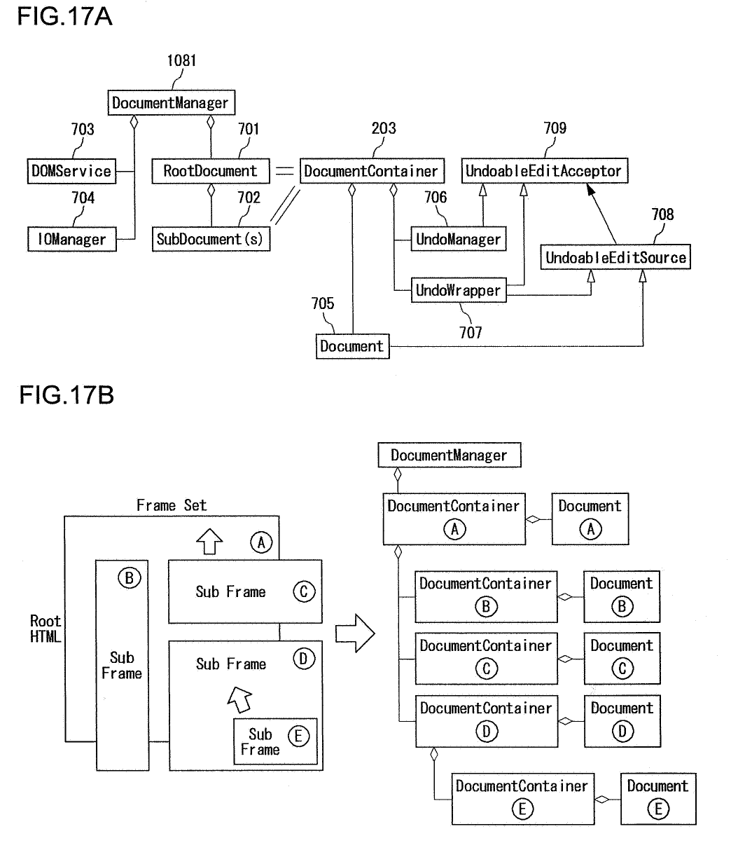

FIG. 17(a) provides a more detailed description of the DocumentManager 1081, and shows the DocumentManager holding documents according to a predetermined structure. As shown in FIG. 11(b), the DocumentManager 1081 manages the documents 1082. With an example shown in FIG. 17(a), one of the multiple documents is a RootDocument (root document) 701, and the other documents are SubDocuments (sub-documents) 702. The DocumentManager 1081 is connected to the RootDocument 701. Furthermore, the RootDocument 701 is connected to all the SubDocuments 702.

As shown in FIG. 12 and FIG. 17(a), the DocumentManager 1081 is connected to the DocumentContainer 203, which is an object for managing all the documents 1082. The tools that form apart of the tool kit 201 (e.g., XML tool kit) including a DOMService 703 and an IOManager 704 are supplied to the DocumentManager 1081. Referring to FIG. 17(a) again, the DOM service 703 creates a DOM tree based upon a document managed by the DocumentManager 1081. Each document 705, whether it is a RootDocument 701 or a SubDocument 702, is managed by a corresponding DocumentContainer 203.

FIG. 17(b) shows the documents A through E managed in a hierarchical manner. The document A is a RootDocument. On the other hand, the documents B through D are the SubDocuments of the document A. The document E is the SubDocument of the document D. The left side in FIG. 17(b) shows an example of the documents displayed on a screen according to the aforementioned hierarchical management structure. In this example, the document A, which is the RootDocument, is displayed in the form of a base frame. On the other hand, the documents B through D, which are the SubDocuments of the document A, are displayed in the form of sub-frames included in the base frame A. On the other hand, the document E, which is the SubDocument of the document D, is displayed on a screen in the form of a sub-frame of the sub-frame D.

Referring to FIG. 17(a) again, an UndoManager (undo manager=undo management unit) 706 and an UndoWrapper (undo wrapper) 707 are created for each DocumentContainer 203. The UndoManager 706 and the UndoWrapper 707 are used for executing an undoable command. Such a feature allows the user to reverse a modification which has been applied to the document according to an editing operation. Here, the modification of the SubDocument significantly affects the RootDocument. The undo operation performed under such an arrangement gives consideration to the modification that affects other hierarchically managed documents, thereby preserving the document integrity over all the documents managed in a particular hierarchical chain, as shown in FIG. 17(b), for example.

The UndoWrapper 707 wraps undo objects with respect to the SubDocuments stored in the DocumentContainer 203. Then, the UndoWrapper 707 connects the undo objects thus wrapped to the undo object with respect to the RootDocument. With such an arrangement, the UndoWrapper 707 acquires available undo objects for an UndoableEditAcceptor (undoable edit acceptor=undoable edit reception unit) 709.

The UndoManager 706 and the UndoWrapper 707 are connected to the UndoableEditAcceptor 709 and an UndoableEditSource (undoable edit source) 708. Note that the Document 705 may be the UndoableEditSource 708 or a source of an undoable edit object, as can be readily understood by those skilled in this art.

### J. Undo Command and Undo Framework

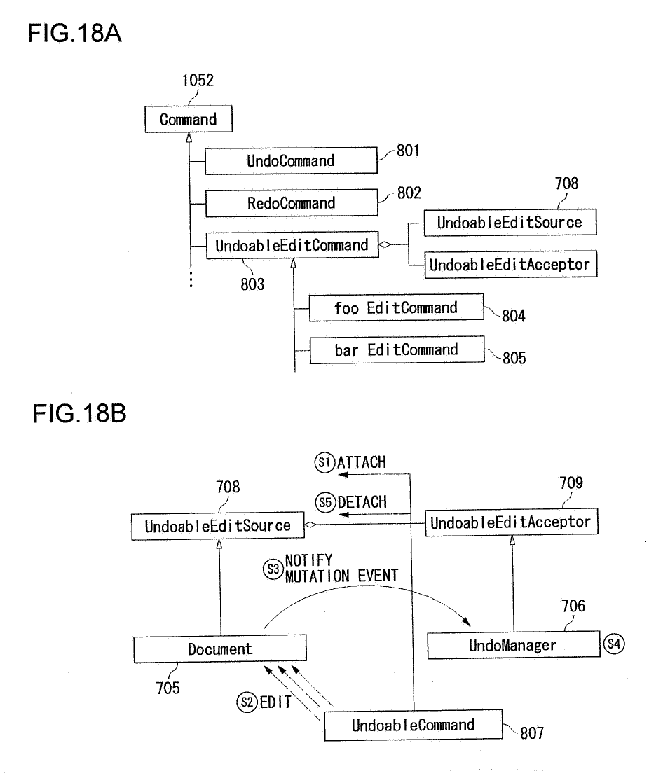

FIG. 18(a) and FIG. 18(b) provide a more detailed description with respect to an undo framework and an undo command. As shown in FIG. 18(a), an UndoCommand 801, RedoCommand 802, and an UndoableEditCommand 803 are commands that can be loaded in the CommandInvoker 1051, and which are serially executed. The UndoableEditCommand 803 is further attached to the UndoableEditSource 708 and the UndoableEditAcceptor 709. Examples of such undoableEditCommands include a “foo” EditCommand and a “bar” EditCommand 805.

### 1. Execution of UndoableEditCommand

FIG. 18(b) shows execution of the UndoableEditCommand. First, let us consider a case in which the user edits the Document 705 using an edit command. In the first step S1, the UndoableEditAcceptor 709 is attached to the UndoableEditSource 708 which is a DOM tree of the Document 705. In the second step S2, the Document 705 is edited using an API for the DOM according to a command issued by the user. In the third step S3, a listener of the mutation event is notified of the modification. That is to say, in this step, the listener that monitors all modifications made to the DOM tree detects such an edit operation. In the fourth step S4, the UndoableEdit is stored as an object of the UndoManager 706. In the fifth step S5, the UndoableEditAcceptor 709 is detached from the UndoableEditSource 708. Here, the UndoableEditSource 708 may be the Document 705 itself.

### K. Procedure for Loading a Document to the System

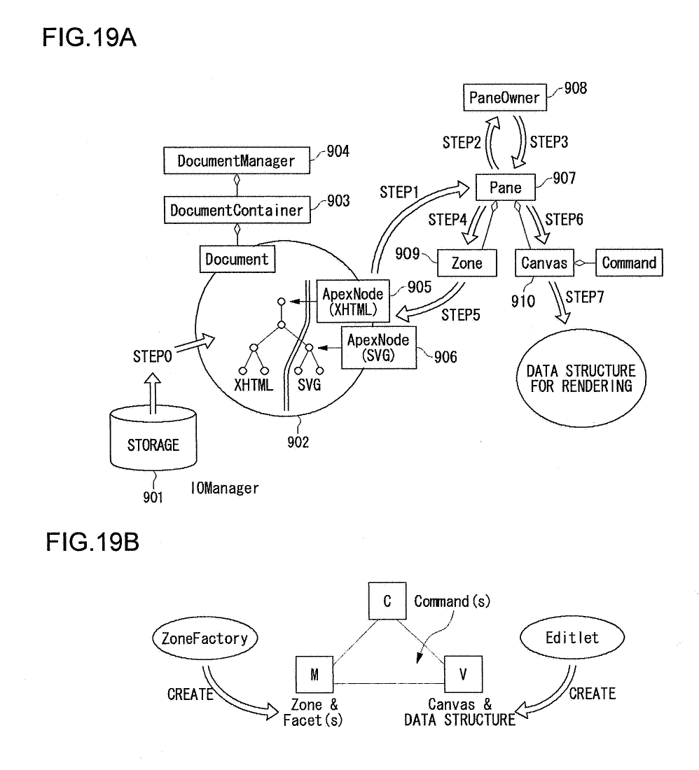

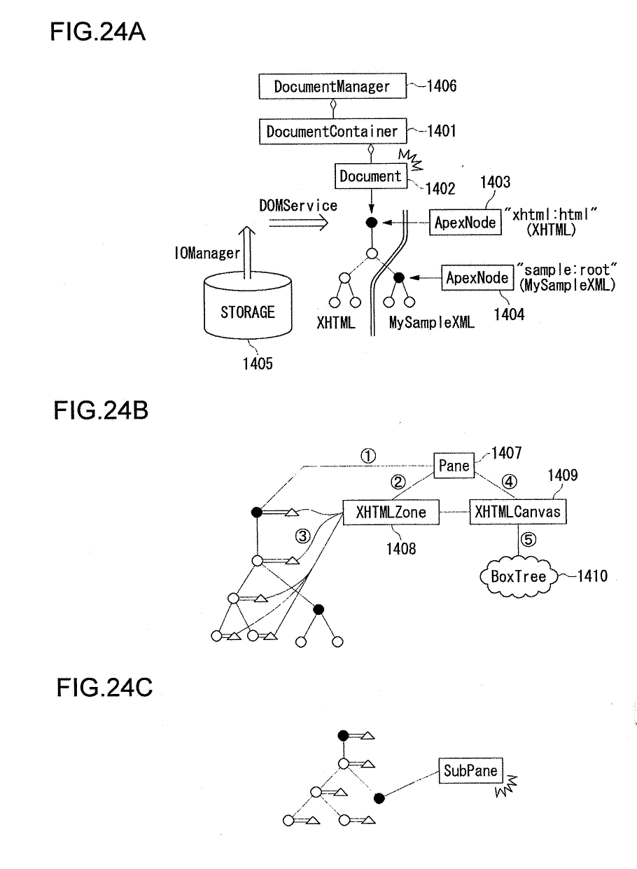

Description has been made in the aforementioned sub-sections regarding various components and sub-components of the system. Description will be made below regarding methods for using such components. FIG. 19(a) shows the outline of the operation for loading a document to the document processing system. Detailed description will be made regarding each step with reference to examples shown in FIGS. 24 through 28.

In brief, the document processing system creates a DOM based upon the document data which is provided in the form of a binary data stream. First, an ApexNode (apex Node=top Node) is created for the targeted part of the document, which is a part of the document that belongs to the Zone. Subsequently, the corresponding Pane is identified. The Pane thus identified creates the Zone and Canvas from the ApexNode and the physical screen. Then, the Zone creates a Facet for each Node, and provides the necessary information to the Facets. On the other hand, the Canvas creates a data structure for rendering the Nodes based upon the DOM tree.

More specifically, the document is loaded from a storage 901. Then, a DOM tree 902 of the document is created. Subsequently, a corresponding DocumentContainer 903 is created for holding the document. The DocumentContainer 903 is attached to the DocumentManager 904. The DOM tree includes the root Node, and in some cases includes multiple secondary Nodes.

Such a document generally includes both text data and graphics data. Accordingly, the DOM tree may include an SVG sub-tree, in addition to an XHTML sub-tree. The XHTML sub-tree includes an ApexNode 905 for XHTML. In the same way, the SVG sub-tree includes an ApexNode 906 for SVG.

In Step 1, the ApexNode 906 is attached to a Pane 907 which is a logical layout of the screen. In Step 2, the Pane 907 issues a request for the CoreComponent which is the PaneOwner (pane owner=owner of the pane) 908 to provide a ZoneFactory for the ApexNode 906. In Step 3, in the form of a response, the PaneOwner 908 provides the ZoneFactory and the Editlet which is a CanvasFactory for the ApexNode 906.

In Step 4, the Pane 907 creates a Zone 909. The Zone 909 is attached to the Pane 907. In Step 5, the Zone 909 creates a Facet for each Node, and attaches the Facets thus created to the respective Nodes. In Step 6, the Pane 907 creates a Canvas 910. The Canvas 910 is attached to the Pane 907. The Canvas 910 includes various Commands. In Step 7, the Canvas 910 creates a data structure for rendering the document on a screen. In a case of XHTML, the data structure includes a box tree structure.

### 1. MVC of the Zone

FIG. 19(b) shows the outline of a structure of the Zone using the MVC paradigm. In this case, with respect to a document, the Zone and the Facets are the input, and accordingly the model (M) includes the Zone and the Facets. On the other hand, the Canvas and the data structure for rendering a document on a screen are the output, in the form of an image displayed on a screen for the user. Accordingly, the view (V) corresponds to the Canvas and the data structure. The Command executes control operations for the document and the various components that correspond to the document. Accordingly, the control (C) includes the Commands included in the Canvas.

### L. Representation of a Document

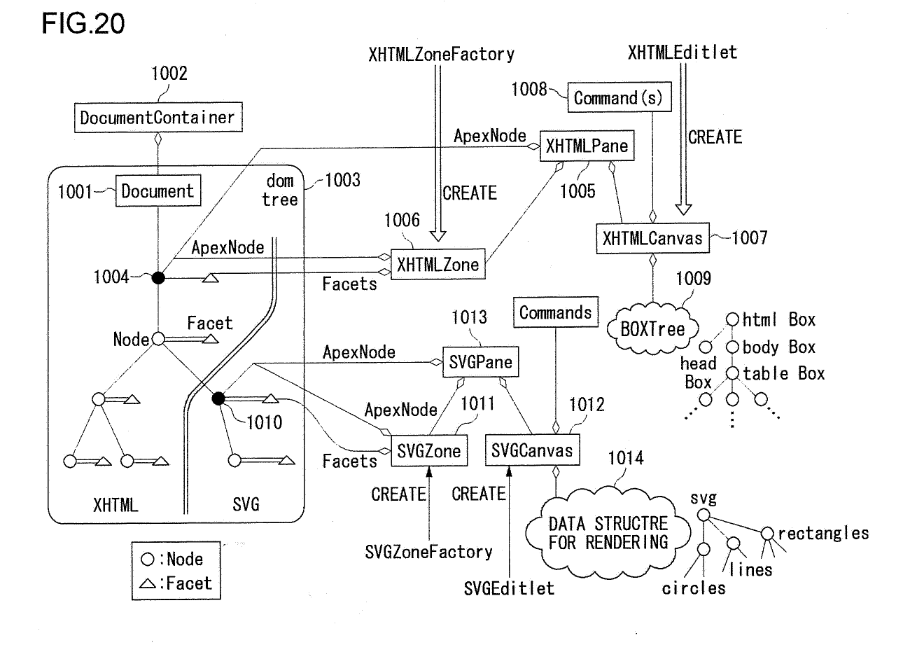

Description will be made below regarding an example of a document and various representations thereof. The document used in this example includes both text data and image data. The text data is represented using XHTML, and the image data is represented using SVG. FIG. 20 shows in detail the relation between the components of the document and the corresponding objects represented in the MVC. In this example, a Document 1001 is attached to a DocumentContainer 1002 for holding the Document 1001. The document is represented in the form of a DOM tree 1003. The DOM tree includes an ApexNode 1004.

The ApexNode is indicated by a solid circle. Each of the Nodes other than the ApexNode is indicated by an empty circle. Each Facet used for editing the Node is indicated by a triangle, and is attached to the corresponding Node. Here, the document includes text data and image data. Accordingly, the DOM tree of the document includes an XHTML component and an SVG component. The ApexNode 1004 is the top Node of the XHTML sub-tree. The ApexNode 1004 is attached to an XHTMLPane 1005 which is the top pane for physically representing the XHTML component of the document. Furthermore, the ApexNode 1004 is attached to an XHTMLZone 1006 which is a part of the DOM tree of the document.

Also, the Facet that corresponds to the Node 1004 is attached to the XHTMLZone 1006. The XHTMLZone 1006 is attached to the XHTMLPane 1005. The XHTMLEditlet creates a XHTMLCanvas 1007 which is a logical representation of the document. The XHTMLCanvas 1007 is attached to the XHTMLPane 1005. The XHTMLCanvas 1007 creates a BoxTree 1009 for the XHTML component of the Document 1001. Various commands 1008 necessary for holding and displaying the XHTML component of the document are added to the XHTMLCanvas 1007.

In the same way, an ApexNode 1010 of the SVG sub-tree of the document is attached to an SVGZone 1011 which is a part of the DOM tree of the document 1001, and which represents the SVG component of the document. The ApexNode 1010 is attached to an SVGPane 1013 which is the top Pane for physically representing the SVG part of the document. An SVGCanvas 1012 for logically representing the SVG component of the document is created by the SVGEditlet, and is attached to an SVGPane 1013. The data structure and the commands for rendering the SVG component of the document on a screen are attached to the SVGCanvas. For example, this data structure may include circles, lines, and rectangles, and so forth, as shown in the drawing.

While description has been made regarding the representation of a document with reference to FIG. 20, further description will be made regarding a part of such examples of the representations of the document using the above-described MVC paradigm with reference to FIG. 21(a). FIG. 21(a) shows a simplified relation between M and V (MV) with respect to the XHTML components of the document 1001. In this case, the model is the XHTMLZone 1101 for the XHTML component of the Document 1001. The tree structure of the XHTMLZone includes several Nodes and the corresponding Facets. With such an arrangement, the corresponding XHTMLZone and the Pane are a part of the model (M) component of the MVC paradigm. On the other hand, the view (V) component of the MVC paradigm corresponds to the XHTMLCanvas 1102 and the BoxTree that correspond to the XHTML component of the Document 1001. With such an arrangement, the XHTML component of the document is displayed on a screen using the Canvas and the Commands included in the Canvas. Note that the events occurring due to the keyboard action and the mouse input proceed in the opposite direction to that of the output.

The SourcePane provides an additional function, i.e., serves as a DOM owner. FIG. 21(b) shows the operation in which the vocabulary connection is provided for the components of the Document 1001 shown in FIG. 21(a). The SourcePane 1103 that serves as a DOM holder includes a source DOM tree of the document. The ConnectorTree (1104?) is created by the ConnectorFactory, and creates the DestinationPane 1105 which also serves as an owner of the destination DOM. The DestinationPane 1105 is provided in the form of the XHTMLDestinationCanvas 1106 having a box tree layout.

### M. The Relation Between Plug-in Sub-System, Vocabulary Connection, and Connector

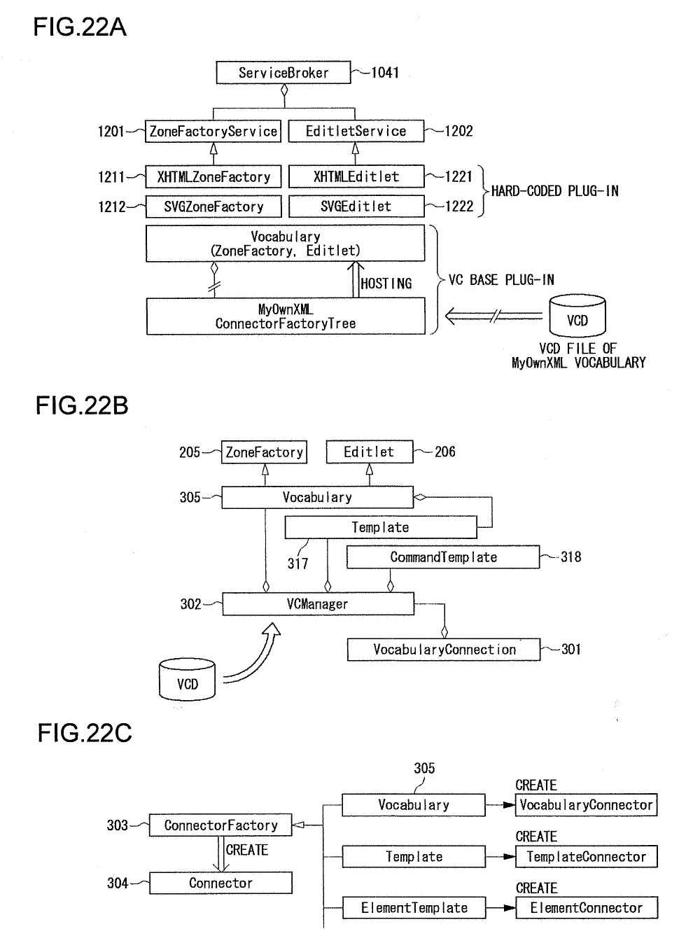

FIGS. 22(a) through 22(c) provide further detailed description with respect to the plug-in sub-system, the vocabulary connection, and the Connector, respectively. The Plug-in sub-system is used for adding a function to the document processing system or for replacing a function of the document processing system. The plug-in sub-system includes the ServiceBroker 1041. A ZoneFactoryService 1201 attached to the ServiceBroker 1041 creates a Zone that corresponds to a part of the document. Also, an EditletService 1202 is attached to the ServiceBroker 1041. The EditletService 1202 creates a Canvas that corresponds to the Nodes included in the Zone.

Examples of the ZoneFactories include an XHTMLZoneFactory 1211 and an SVGZoneFactory 1212, which create an XHTMLZone and an SVGZone, respectively. As described above with reference to an example of the document, the text components of the document may be represented by creating an XHTMLZone. On the other hand, the image data may be represented using an SVGZone. Examples of the EditletService include an XHTMLEditlet 1221 and an SVGEditlet 1222.

FIG. 22(b) shows the vocabulary connection in more detail. The vocabulary connection is an important feature of the document processing system, which allows a document to be represented and displayed in two different manners while maintaining the integrity of the document. The VCManager 302 that holds the ConnectorFactory 303 is a part of the vocabulary connection sub-system. The ConnectorFactory 303 creates the Connector 304 for the document. As described above, the Connector monitors the Node included in the source DOM, and modifies the Node included in the destination DOM so as to maintain the integrity of the connection between the two representations.

A Template 317 represents several Node conversion rules. The vocabulary connection descriptor (VCD) file is a template list which represents several rules for converting a particular path, an element, or a set of elements that satisfies a predetermined rule into another element. All the Templates 317 and CommandTemplates 318 are attached to the VCManager 302. The VCManager is an object for managing all the sections included in the VCD file. A VCManager object is created for each VCD file.

FIG. 22(c) provides further detailed description with respect to the Connector. The ConnectorFactory 303 creates a Connector based upon the source document. The ConnectorFactory 303 is attached to the Vocabulary, the Template, and the ElementTemplate, thereby creating a VocabularyConnector, a TemplateConnector, and an ElementConnector, respectively.

The VCManager 302 holds the ConnectorFactory 303. In order to create a Vocabulary, the corresponding VCD file is read out. As described above, the ConnectorFactory 303 is created. The ConnectorFactory 303 corresponds to the ZoneFactory for creating a Zone, and the Editlet for creating a Canvas.

Subsequently, the EditletService for the target vocabulary creates a VCCanvas. The VCCanvas also creates the Connector for the ApexNode included in the source DOM tree or the Zone. As necessary, a Connector is created recursively for each child. The ConnectorTree is created using a set of the templates stored in the VCD file.

The template is a set of rules for converting elements of a markup language to other elements. For example, each template is matched to a source DOM tree or a Zone. In a case of a suitable match, an apex Connector is created. For example, a template “A/*/D” matches all the branches starting from the Node A and ending with the Node D. In the same way, a template “//B” matches all the “B” Nodes from the root.

N. Example of VCD File with Respect to ConnectorTree

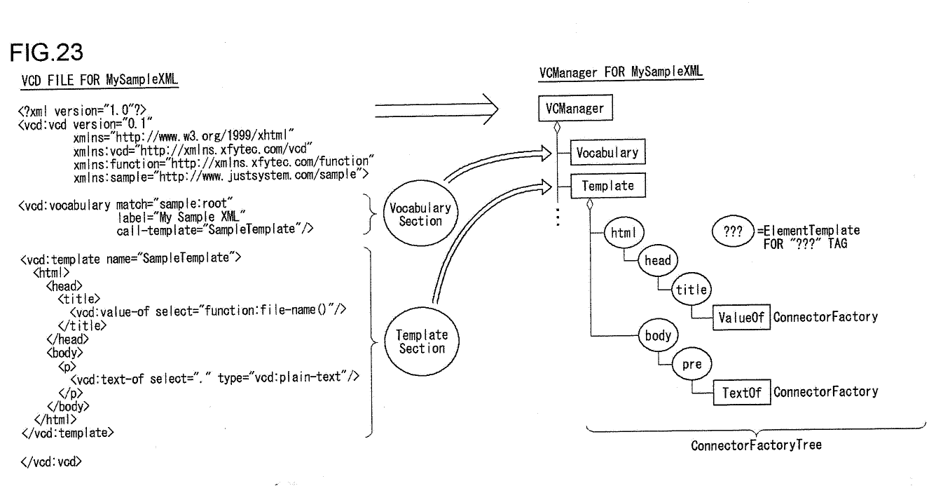

Further description will be made regarding an example of the processing with respect to a predetermined document. In this example, a document entitled “MySampleXML” is loaded in the document processing system. FIG. 23 shows an example of the VCD script for the “MySampleXML” file, which uses the VCManager and the ConnectorFactoryTree. In this example, the script file includes a vocabulary section, a template section, and a component that corresponds to the VCManager. With regard to the tag “vcd:vocabulary”, the attribute “match” is set to “sample:root”, the attribute “label” is set to “MySampleXML”, and the attribute “call-template” is set to “sample template”.

In this example, with regard to the VCManager for the document “MySampleXML”, the Vocabulary includes the apex element “sample:root”. The “MySampleXML”. In the template section, the tag is “vcd:template”, and the name is set to “sample:template”.

### O. Detailed Description of an Example of a Method for Loading a File to the System

FIGS. 24 through 28 provide a detailed description regarding loading the document “MySampleXML” in the system. In Step 1 shown in FIG. 24(a), the document is loaded from a storage 1405. The DOMService creates a DOM tree and a DocumentContainer 1401 that corresponds to the DocumentManager 1406. The DocumentContainer 1401 is attached to the DocumentManager 1406. The document includes an XHTML sub-tree and a MySampleXML sub-tree. With such a document, the ApexNode 1403 in the XHTML sub-tree is the top Node of the XHTML sub-tree, to which the tag “xhtml:html” is assigned. On the other hand, the ApexNode 1404 in the “MySampleXML” sub-tree is the top Node of the “MySampleXML” sub-tree, to which the tag “sample:root” is assigned.

In Step S2 shown in FIG. 24(b), the RootPane creates an XHTMLZone, Facets, and a Canvas. Specifically, a Pane 1407, an XHTMLZone 1408, an XHTMLCanvas 1409, and a BoxTree 1410 are created corresponding to the ApexNode 1403.

In Step S3 shown in FIG. 24(c), the tag “sample:root” that is not understood under the XHTMLZone sub-tree is detected, and a SubPane is created in the XHTMLCanvas region.

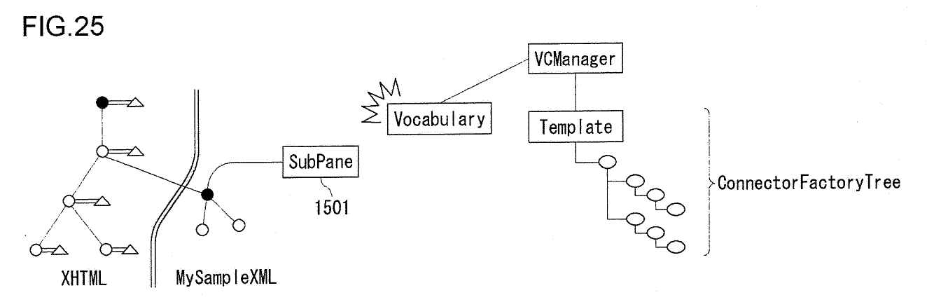

In Step 4 shown in FIG. 25, the SubPane can handle the “sample:root”, thereby providing a ZoneFactory having a function of creating an appropriate zone. The ZoneFactory is included in the vocabulary, and the vocabulary can execute the ZoneFactory. The vocabulary includes the content of the VocabularySection specified in “MySampleXML”.

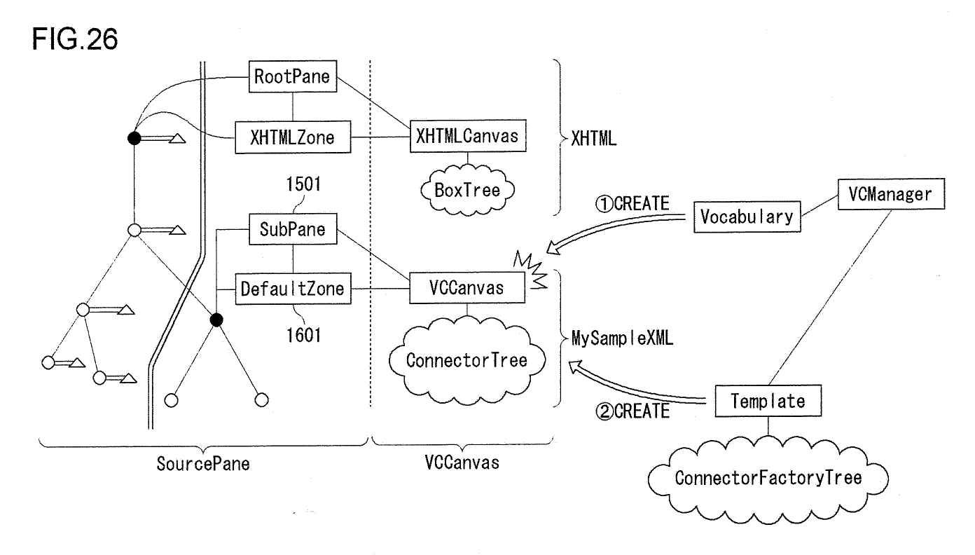

In Step 5 shown in FIG. 26, the Vocabulary that corresponds to “MySampleXML” creates a DefaultZone 1601. In order to create a corresponding Editlet for creating a corresponding Canvas, a SubPane 1501 is provided. The Editlet creates a VCCanvas. The VCCanvas calls the TemplateSection including a ConnectorFactoryTree. The ConnectorFactoryTree creates all the connectors that form the ConnectorTree.

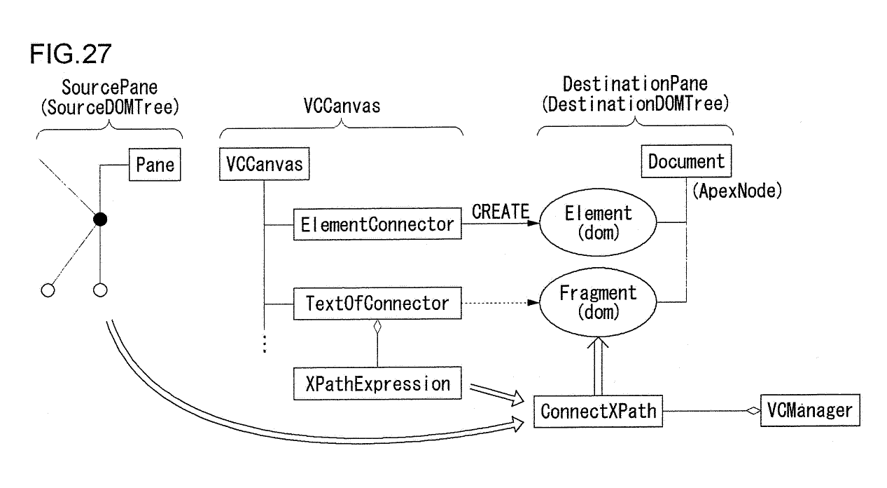

In Step S6 shown in FIG. 27, each Connector creates a corresponding destination DOM object. Some of the connectors include XPath information. Here, the XPath information includes one or more XPath representations used for determining a partial set of the source DOM tree which is to be monitored for changes and modifications.

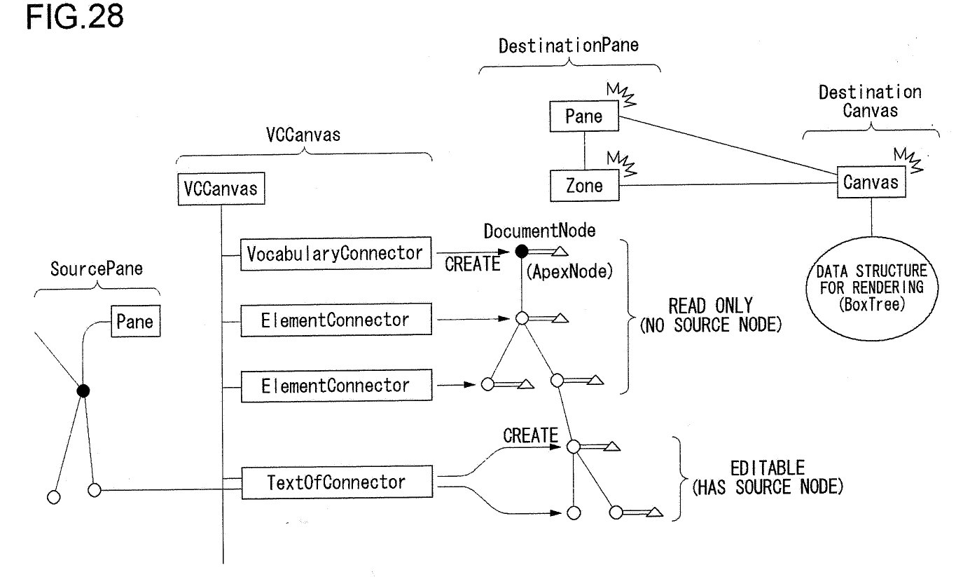

In Step S7 shown in FIG. 28, the vocabulary creates a DestinationPane for the destination DOM tree based upon the pane for the source DOM. Specifically, the DestinationPane is created based upon the SourcePane. The ApexNode of the destination tree is attached to the DestinationPane and the corresponding Zone. The DestinationPane creates a DestinationCanvas. Furthermore, the DestinationPane is provided with a data structure for rendering the document in a destination format and an Editlet for the DestinationPane itself.

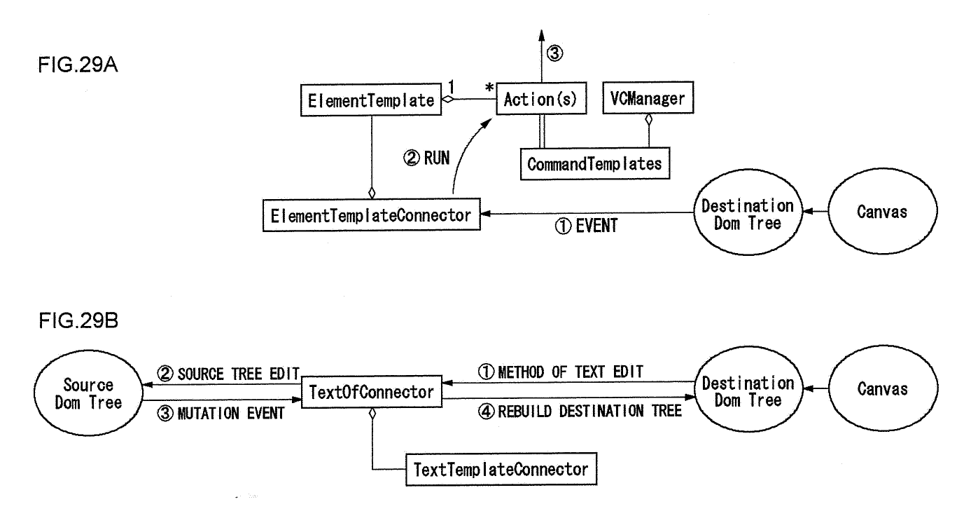

FIG. 29(a) shows a flow in a case in which an event has occurred at a Node in the destination tree that has no corresponding source Node. In this case, the event acquired by the Canvas is transmitted to an ElementTemplateConnector via the destination tree. The ElementTemplateConnector has no corresponding source Node, and accordingly, the event thus transmitted does not involve an edit operation for the source Node. In a case that the event thus transmitted matches any of the commands described in the CommandTemplate, the ElementTemplateConnector executes the Action that corresponds to the command. On the other hand, in a case that there is no corresponding command, the ElementTemplateConnector ignores the event thus transmitted.

FIG. 29(b) shows a flow in a case in which an event has occurred at a Node in the destination tree that has been associated with a source Node via a TextOfConnector. The TextOfConnector acquires the text Node from the Node in the source DOM tree specified by the XPath, and maps the text Node to the corresponding Node in the destination DOM tree. The event acquired by the Canvas, such as a mouse event, a keyboard event, or the like, is transmitted to the TextOfConnector via the destination tree. The TextOfConnector maps the event thus transmitted to a corresponding edit command for the corresponding source Node, and the edit command thus mapped is loaded in the CommandQueue 1053. The edit commands are provided in the form of an API call set for the DOM executed via the Facet. When the command loaded in the queue is executed, the source Node is edited. When the source Node is edited, a mutation event is issued, thereby notifying the TextOfConnector, which has been registered as a listener, of the modification of the source Node. Then, the TextOfConnector rebuilds the destination tree such that the destination Node is modified according to the modification of the source Node. In this stage, in a case that the template including the TextOfConnector includes a control statement such as “for each”, “for loop”, or the like, the ConnectorFactory reanalyzes the control statement. Furthermore, the TextOfConnector is rebuilt, following which the destination tree is rebuilt.

### EMBODIMENT

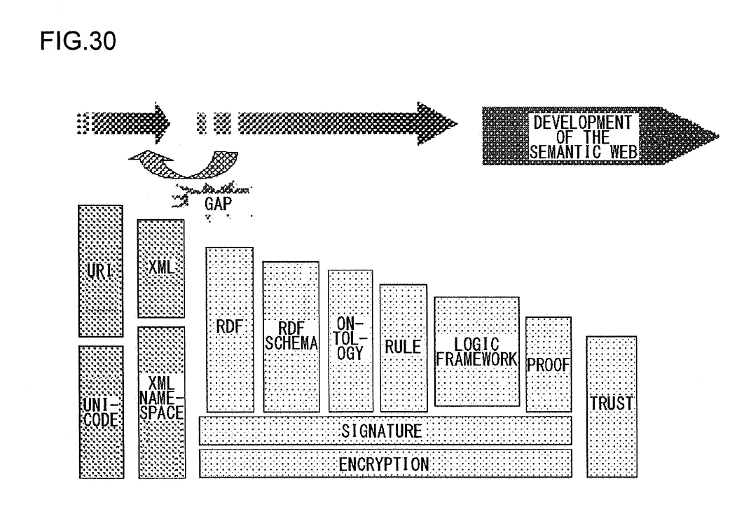

FIG. 30 is a schematic diagram which shows layer cakes of the Semantic Web. As described above, the document processing apparatus 20 shown in the base technology is effective as an XML document (XML data) handling technology in each scene, such as a composite document and Web service. 1) In the development of the Semantic Web shown by the layer cakes in the Figure, it can be said that it is a big challenge to handle seamlessly the data structures from “XML” through “RDF (Resource Description Framework)” and beyond. 2) It is also expected that it is difficult to be realized soon that all documents will be described in RDF. 3) Therefore, a technology is desired to be realized, in which the conventional XML-based data and the RDF data and beyond are connected together. 4) In this case, the XML handling technology shown in the base technology may possibly be a key technology which can connect the existing XML-based data and a Semantic Web application together, by using the common language “XML.”

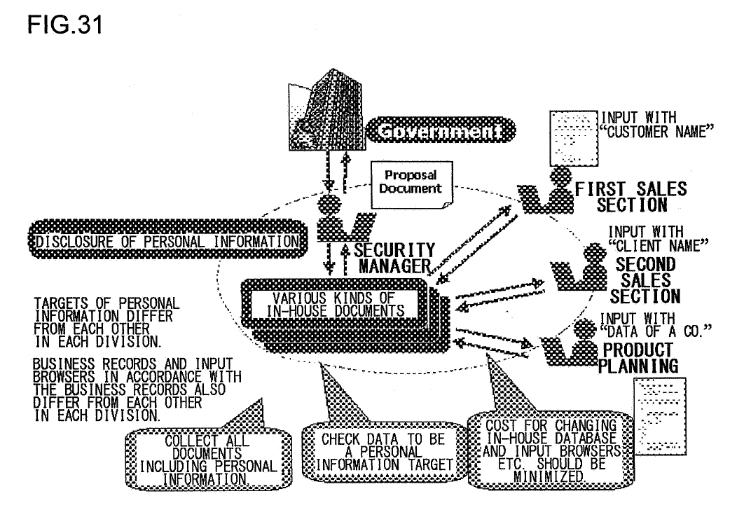

FIG. 31 is a schematic diagram which shows a general form of handling various document files including personal information. A general purpose of the present embodiment is to centrally manage document files, such as business records created separately in each division, and input browsers for inputting the document files, without a great change. To achieve this, the global data, after being defined as an in-house standard (then, the global data becomes a model), is associated with a local data definition in each division by an ontology technology. Therefore, collection of data and addition of information can be performed from/to an existing XML-structured in-house documents and input browsers for inputting documents, at the minimum cost, by an XML handling technology.

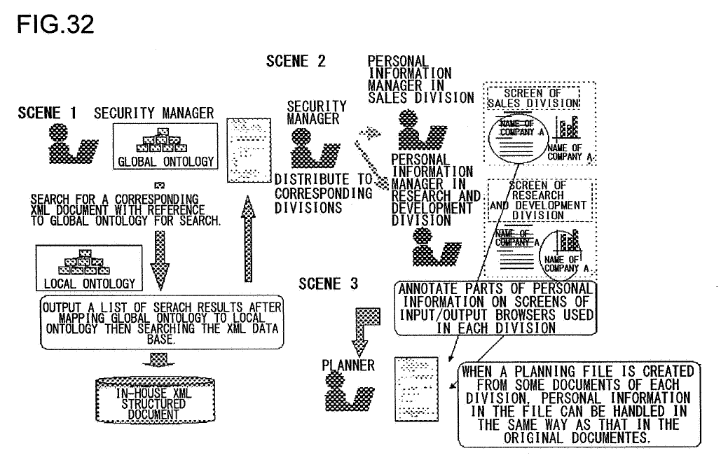

FIG. 32 is a diagram which shows a flow of the personal information management support system of the present embodiment.

### <Scene 1>

A security manager collects personal information included in a document file in each division. There is a huge variation with respect to local terms used in a document file in each division. Therefore, a security manager does not grasp these local terms completely. However, in the Figure, an ontology with respect to a structure and an attribute of a document is defined by an in-house standard (such an ontology is hereinafter referred to as a “global ontology.”) In each division, local terms of each division are linked to the terms of a global ontology as a local ontology. Due to this, a global ontology as an in-house standard and a local ontology in each division are connected together seamlessly. In searching a document file created based on a local ontology from an in-house database, search using a semantically superordinate concept is performed based on a global ontology which is an in-house standard. The semantically superordinate concept is converted into a term actually used in each division. XML structured documents are then searched from an in-house database and the results are displayed in a list.

Element Technology to be used:

1. A global ontology standardized in the whole company and a local ontology mapped to the global ontology

2. A function for searching an in-house database and displaying a list of the results, after proceeding from a global ontology to a local ontology

### <Scene 2>

A document file displayed in a list as a result of search is distributed to each division. A manager of each division, after checking personal information in the document file distributed, such as a name of a person and an address, gives an annotation, for example, “corresponding to personal information processing”, to the personal information. At the time, an annotation is given to by using local terms in each division.

When a new document to be provided externally is created based on document files in the sales division and the development division, the annotation, “corresponding to personal information processing”, is also available, as long as a text in which an annotation is set is used. That is, such annotation information is maintained even if the data of a document file is used secondarily or thirdly.

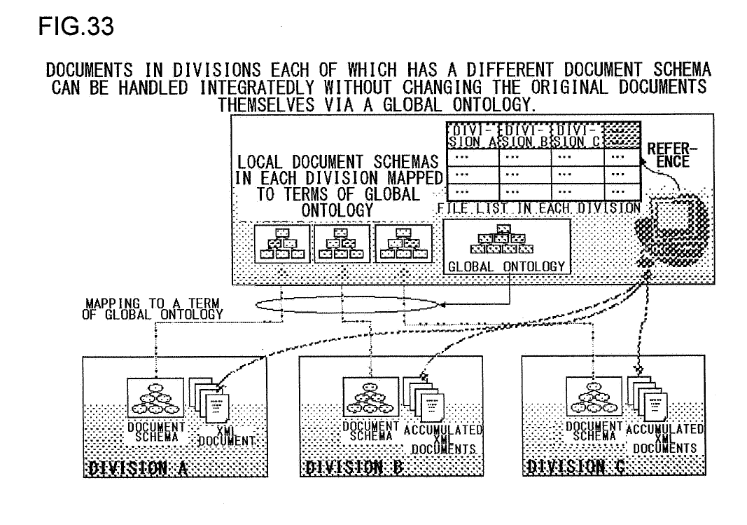

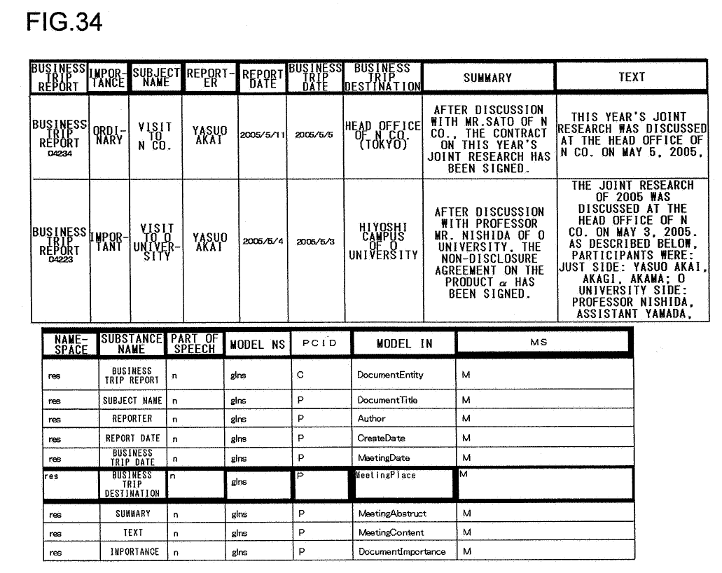

FIG. 33 is a schematic diagram which explains the scene 1 of FIG. 32 in detail. As explained with reference to FIG. 34 and subsequent figures, a tag used as an in-house standard is defined as a global ontology. That is, a type of a document file and each tag described therein are defined conceptually and generally in the whole company. As an example of that, it is assumed that a schema including tags, such as “Creater” and “CreateDate”, i.e., a global ontology is defined as the property of the tag “Doc.” On the other hand, in the sales division, a schema including tags, such as “reporter” and “report date”, i.e., a local ontology is defined as the property of the tag “sales daily report.” Here, the tag “sales daily report” is a tag inheriting the tag “Doc.” Similarly, the tags, “reporter” and “report date”, inherit the tags, “Creater” tag and “CreateDate”, respectively. A tag defined based on a global ontology is hereinafter referred to as a “model tag.”

Now, it is assumed that the tag “MeetingPlace” relating to address is a model tag defined by a global ontology. A security manager searches data in a document file based on a local ontology, by using the model tag “MeetingPlace.” The model tag “MeetingPlace” is renamed the tag “business trip destination” in the research division, whereas renamed the tag “address” in the sales division. That is, the tag “MeetingPlace” in a global ontology has a tag name in accordance with the business of each division, such as “business trip destination” or “address”, in a local ontology. A tag defined based on a local ontology is hereinafter referred to as a “substance tag.”

FIG. 34 is a diagram which shows a relation between a global ontology and local ontology in the research division. As shown here, the tag “MeetingPlace” in a global ontology is mapped to the tag “business trip destination” in the research division. In a global ontology, “MeetingPlace” is defined as the property of the class “DocumentEntity.” A data structure of a model tag as an in-house standard is the origin of a data structure of a substance tag in a document file in each division, as it is. A document file created based on a global ontology which is an in-house standard is hereinafter referred to as a “parent document file”, and a tag structure thereof referred to as a “parent schema.” Furthermore, a document file which has a schema inheriting a parent schema (the schema is hereinafter referred to as a “child schema”) and is created based on a local ontology in each division, is hereinafter referred to as a “child document file.” A display layout of a child document file may be created in each division, or a standard display layout may be provided in advance.

As shown in the Figure, the property of a substance tag inherits the property of a model tag as it is. On the other hand, a name of a substance tag can be renamed in accordance with the business of each division. For storage, a child document file is coupled with a tag mapping table which maps substance tags to model tags. For example, the tag “business trip destination” is mapped to the tag “MeetingPlace” which is its origin.

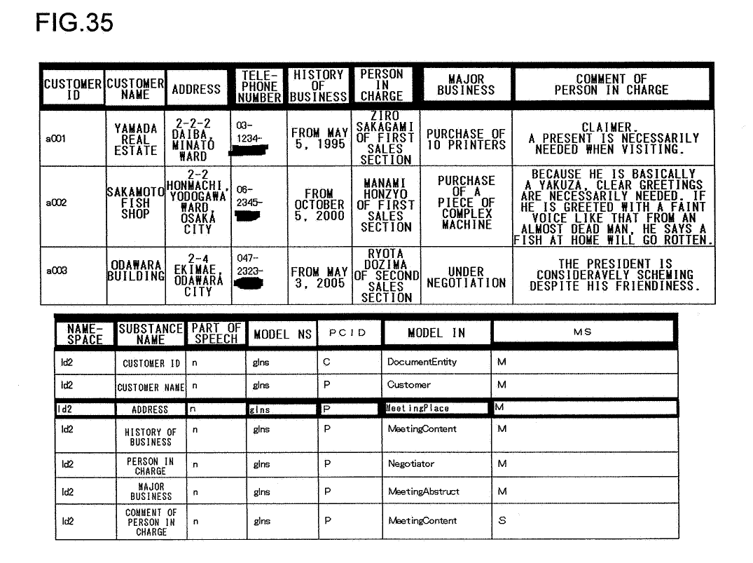

FIG. 35 is a diagram which shows a relation between a global ontology and a local ontology in the sales division. As shown here, the tag “MeetingPlace” in a global ontology is mapped to the tag “address” in the sales division.

A security manager can search for the data inputted in a substance tag inheriting, for example, the model tag “MeetingPlace”, from various child document files in the company. When a security manager searches an in-house database by using the tag “MeetingPlace” as a search key, a name of a substance tag corresponding thereto is identified for each child schema by referring to the tag mapping table previously described. For example, when search of a document file used in the research division is ordered by using the tag “MeetingPlace” as a search key, the search key is mapped to the name of the tag “business trip destination.” Then, the data stored in the tag “business trip destination” can be detected from a child document file. Therefore, a security manager can centrally search for the desired data from in-house documents by using a name of a model tag, even if he/she does not know a name of a substance tag. On the other hand, since a user of a child document file in each division can set a substance tag name freely, as long as a child document file follows a global ontology, convenience for a security manager and a user in each division to handle an in-house document can be improved.

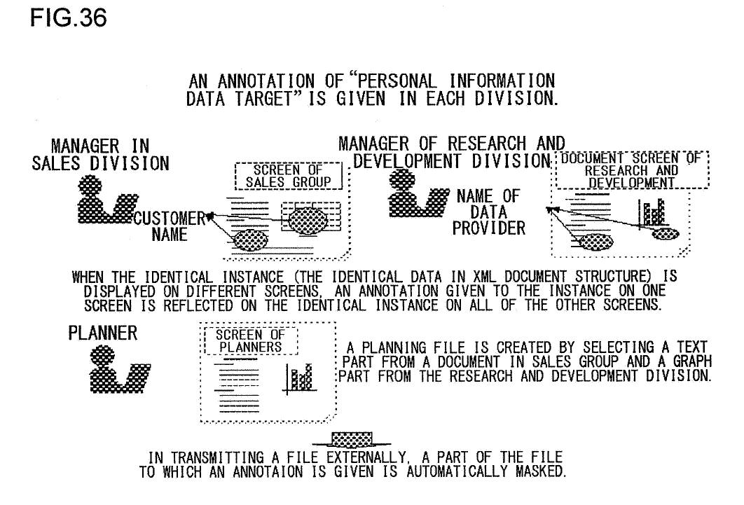

FIG. 36 is a schematic diagram which explains a manner in which an annotation is given to a child document file.

1. In the research division, an annotation which shows the “personal information target data” is set in the personal information, such as a name of a person and an address.
2. When a child document file is displayed in two or more types of display layouts at the same time, an annotation setting in one display screen is simultaneously reflected on other display screens as an annotation setting therein. This is because an annotation is set in the “data” in a child document file. A technology by a mutation event described in the base technology is applied.
3. In the sales division, an annotation which shows the “personal information target data” is also set in the personal information, such as a name of a person and an address.
4. When a planner creates a new planning file by using these 2 documents, i.e., child document files in the research division and sales division, respective annotation information in the files is maintained.
5. In transmitting a planning file externally, it is prevented that the part of the file in relation to the personal information is disclosed externally, by masking the part of the file in which the annotation is set, by the security system of a company.

It can be said that such an annotation is one type of constituting elements of a structured document file, like a tag. A parent schema includes multiple types of annotations based on a global ontology like, for example, the annotation “Important.” On the other hand, a child schema includes an annotation inheriting the annotation “Important.” A user can rename a name of an annotation in a child schema (the annotation is hereinafter referred to as a “substance annotation”) in the same way as a substance tag. The annotation “Important” can be renamed an annotation like, for example, the annotation “trade secrets”, in accordance with the business.

The property of each substance annotation in a child schema inherits the property of an annotation in a parent schema (the annotation defined based on a global ontology is hereinafter referred to as a “model annotation”) as it is. For storage, a child document file is coupled with an annotation mapping table which maps substance annotations to model annotations by a parent schema.

When a security manager searches an in-house database by using a model annotation as a search key, a name of a corresponding substance annotation is identified for each child schema by the annotation mapping table previously described. For example, when search is ordered by using the annotation “Important” as a search key, the annotation is mapped to the annotation “trade-secrets” in a child document file in the sales division. Then, the data in which the annotation “trade-secrets” is set can be detected from a child document file. Therefore, a security manager can centrally search for the desired data from an in-house document by using a name of an annotation, even if he/she does not know a name of a substance annotation. On the other hand, since a user of a child document file in each division can set an annotation name freely, as long as a child document file follows a global ontology, convenience for a security manager and a user in each division to handle an in-house document can be improved.

In the case of an annotation, there is a merit that an annotation is not necessarily restricted by a schema of a tag. For example, one type of annotation may be set in the two types of data inputted into the tags “MeetingPlace” and “MeetingContent.” Alternatively, an annotation may be set in a part of the data inputted into the tag “MeetingPlace.” As model annotations, various types of annotations, for example, such as an annotation for specifying personal information or for specifying important information, may be provided. A substance annotation inheriting a model annotation for specifying personal information may be set in the part of data which corresponds to the personal information in a child document file. And, for example, the data in which a substance annotation inheriting a model annotation for specifying personal information is set, may be handled so as not to be transmitted externally. More specifically, personal information in a child document file may be identified by the security system using a model annotation for specifying personal information as a search key, and the information may be handled so as not to be transmitted externally by masking the data.

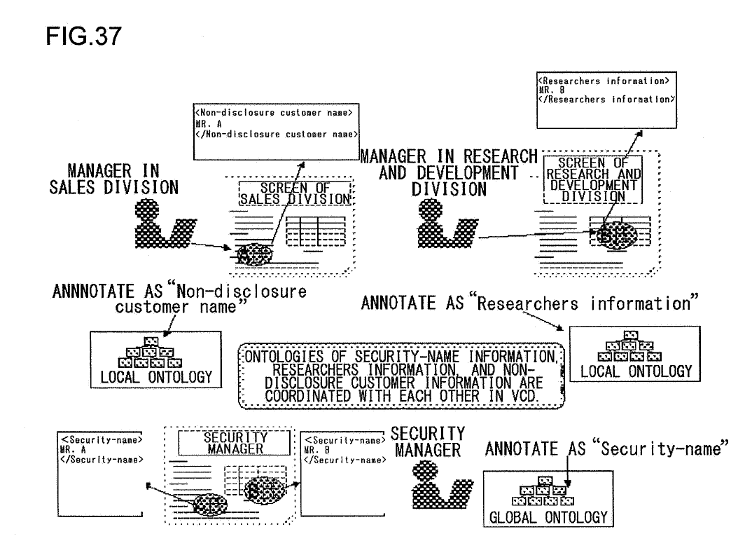

FIG. 37 is a schematic diagram which explains the security management by an annotation. 1. A security manager manages a tag for specifying personal information, with the name of the tag “SecurityName”, in order to give the tag to an in-house document file. 2. In the sales division, an annotation with the original name of “Non-disclosure customer information” is set so that personal information is easily recognized in a document file in the division, whereas in the research division, an annotation with the original name of “Researchers information” is set. As shown in the Figure, in the sales division, the annotation “Non-disclosure customer information” is set as a tag, in order to annotate the data “Mr. A.” On the other hand, in the research division, the annotation “Researchers information” is set as a tag, in order to annotate the data “Mr. B.” 3. These relations are connected together by a VCD. That is, a processing is provided as a VCD in which a tag in each division, which is used for annotating personal information, is mapped to the tag “SecurityName” which is an in-house standard. 4. A security manager can thus manage personal information centrally by “SecutrityName”, even if an annotation is set in local terms in each division.

An annotation may be set in any one of: a tag of a child document file; the whole or a part of data inputted for a tag; or a set of data inputted for a plurality of tags.

Next, two data processing functions based on a tag will be mentioned.

Function name: ont_searh

Argument: A local domain, a substance tag

Return value: A list of substance tags in all the domains inheriting the model tag which is the origin of the specified substance tag

Description: A list of all the substance tags, which corresponds to the same class of a global ontology as the substance tag specified, is acquired. The function, after acquiring a DOM tree first, acquires the model tag “MeetingPlace” which is the origin of the substance tag “Address” in the sales division. The function then detects the tag “Business Trip Destination” in the research division, in which the tag inherits the model tag. Search can thus be performed by specifying a concept which corresponds to a node which is desired to be acquired (a class of an ontology), or specifying a tag of other domain corresponding to the node described above. In other words, search can be performed even if a domain to be a search target is unknown.

Sample: <vcd:for-each
select=“function:ont_search(function:document(“*.xml”)//*/sales division: address)”>
In the case of this sample, all the files, in the current directory, of which extensions are xml are parsed, and a list of nodes corresponding to the same class of the global ontology as the sales division: address, is acquired from the files.

Function name: ont_call

Argument: A target domain, a command name

Return value: Execute a command defined for VCD in the target domain.

Description: When display or editing is performed by converting domains in an ontology, it is difficult to guarantee that the schema of a document to be edited is maintained, since a domain in which an editing command is described is different from the domain in which the document is edited. Therefore, for example, an interface of a particular editing command, in which a tag is given to personal information, is defined by a global ontology. An editing command can be defined in accordance with a schema in each domain by implementing these editing commands in a local ontology in each domain. The command is defined as a VCD command for processing each domain. “Sample: <vcd:action event=“event:mouse-clicked”><instruction:callname=”function:o nt-call(annotate-privacy, $contextNS) “/></vcd:action> In the case of this sample, when a mouse is clicked at a corresponding position, the command annotate-privacy, which is defined by $contextNS domain, will be executed.

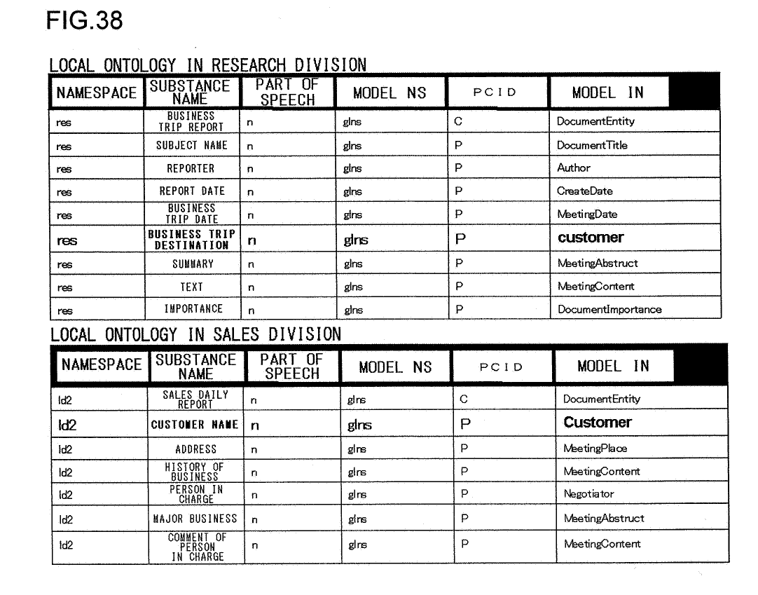

FIG. 38 is a diagram which shows another example of the tag mapping table explained in relation to FIGS. 34 and 35. The model tag defined as “Customer” is defined as “business trip destination” in the research division, and defined as “customer name” in the sales division. In searching for the information which could be the personal information, if a security manager has such knowledge, he/she can then search for the necessary information only with the tags in the order of from “DocumentEntry” to “Customer”, without having to search for the corresponding data with the local tag names in the order of from “research division” to “business trip report” then to “business trip destination”, or in the order of from “sales division” to “sales daily report” then to “customer name.”

The features of the document processing technology of the present embodiment, which are mentioned above, will be summarized as follows:

### 1. Fusion of XML Technology and Semantic Web Technology

By making the document processing apparatus 20 a platform, it becomes possible that the Semantic Web technologies, such as RDF, RDFS (Resource Description Framework Schema), or OWL (Web Ontology Language), and the XML technology can be connected together seamlessly.

2. Data Consistency from the Human Readable Data to the Machine Readable Data

Consistency between a browser, which deals with the data that matters in the real world, and the data can be handled uniformly by the document processing apparatus 20, as well as consistency between the data from the human readable data and the machine readable data, as envisaged in the Semantic Web technology.

3. A personal information managing support system, in which each technology of articles 1 and 2 described above is coordinated with each other, can be practiced by making the document processing apparatus 20 a platform. A data processing method shown in the aforementioned embodiment has an advantage in that it becomes easier to maintain data consistency of a document file handled in a business organization such as a company.

Further description will be made in relation to the present invention. So far, mapping between model tags and substance tags, and an application scene thereof have been described as a main subject. For example, after preparing a set of model tags which is a standard in a company (the set is hereinafter referred to as a “model tag set”), each division may create a substance tag based on the model tag set, in accordance with its business, and may create an XML document file based on the substance tag. In this case, the development division, the marketing division, and the sales division will create XML documents based on different substance tags, respectively. Although sets of substance tags (the set is hereinafter referred to as a “substance tag set”) are different from each other, since the substance tag sets inherit the identical model tag set, search for information can be performed based on the model tag.

For example, it is assumed that the model tag<employee> is the origin of the substance tags, <section manager> and <person in charge of license>, and an XML document file described by such substance tags is considered. More specifically, if an XML document file includes two elements: <section manager> Kato </section manager>; and <person in charge of license> Hasegawa </person in charge of license>, the two pieces of element data, “Kato” and “Hasegawa”, can be detected when data detection is ordered in which the model tag <employee> is to be a search target. This is because the model tag <employee> and the substance tags, <section manager> and <person in charge of license>, are associated with each other internally. The information to be required can be acquired from the element data of a substance tag by using a model tag as a search key, as long as the substance tag is created in a way of inheriting the model tag. The benefit is available not only in connection with tags but also in connection with annotations. A way of mapping is hereinafter referred to as a “top-down approach”, in which a substance tag is created in a way of inheriting such a model tag, and the model tag and the substance tag created are mapped to each other.

In another scene, various substance tags currently used in an XML document file may be mapped to model tags. Such a way of mapping is hereinafter referred to as a “bottom-up approach.” In a “bottom-up approach”, a substance tag may be defined freely by a user without having to be created to inherit a model tag. It is assumed that an XML document file includes substance tags, <section manager> and <person in charge of license>. It is assumed that these substance tags are defined freely by a user without a particular restriction, and are not tags created based on a model tag. On the other hand, for the aforementioned model tag <employee>, tags which correspond to words representing various subordinate concepts or which correspond to synonyms, such as <president>, <section manager>, <person in charge of license>, <new employee>, and <project leader>, are defined in advance. When names of a model tag and substance tag are in a relation between a word representing a superordinate concept and a word representing a subordinate concept, these tags will be associated with each other automatically. Since the substance tag <section manager> of an XML document file is a word representing a subordinate concept being covered by the model tag <employee>, the model tag <employee> is automatically associated with the substance tag <section manager>. According to such a manner, a tag included in an existing XML document file can be automatically connected to a standard model tag.

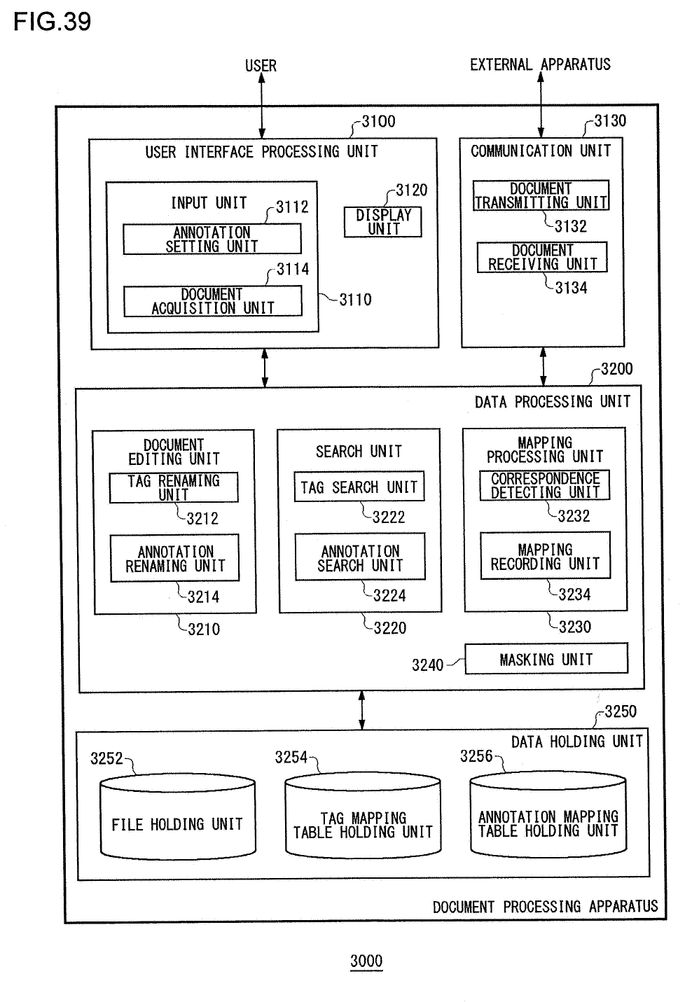

FIG. 39 is a functional block diagram of the document processing apparatus 3000 which realizes a function for mapping substance tags to model tags, using the various functions of the document processing apparatus 20 explained in the base technology. Although each block shown here can be practiced by an element and a machine including a CPU of a computer in terms of hardware, and practiced by a computer program etc., in terms of software, functional blocks which are practiced by cooperation of the hardware and software are illustrated herein. Accordingly, it should be understood by a person skilled in the art that these functional blocks can be practiced in a variety of forms by combinations of the hardware and software.

The document processing apparatus 3000 includes a user interface processing unit 3100, a communication unit 3130, a data processing unit 3200, and a data holding unit 3250. The user interface processing unit 3100 is in charge of the entire processing with respect to the user interface, such as a processing of an input from a user or a display of information to a user. The present embodiment will be explained assuming that a user interface service of the document processing apparatus 3000 is provided by the user interface processing unit 3100. As another example, the document processing apparatus 3000 may be operated by a user via the Internet. In this case, the communication unit 3130 receives the operation direction information from a user terminal, and transmits the information on a result of processing executed based on the operation direction, to the user terminal.

The data processing unit 3200 executes various data processings based on the data acquired from the user interface processing unit 3100 or the communication unit 3130. The data processing unit 3200 also plays a role of interface between the user interface processing unit 3100 and the data holding unit 3250. The data holding unit 3250 stores various data, such as the setting data provided in advance or the data received from the data processing unit 3200.

The user interface processing unit 3100 includes the input unit 3110 which receives an input from a user, and the display unit 3120 which displays various types of information to a user. A function of the display unit 3120 is realized by the display unit 56 or the like of the document processing apparatus 20 explained in the base technology. The input unit 3110 includes the annotation setting unit 3112 and the document acquisition unit 3114. The annotation setting unit 3112 sets an annotation in an XML document based on a user's direction input. An annotation is set as an attribute of a tag. The document acquisition unit 3114 acquires an XML document file which is to be a processing target.

The communications unit 3130 communicates with an external apparatus, such as other document processing apparatus 3000 or a certain server apparatus. The communication unit 3130 includes the document transmitting unit 3132 and the document receiving unit 3134. The document transmitting unit 3132 transmits an XML document file to an external apparatus. The document receiving unit 3134 receives an XML document file from an external apparatus. In this way, the document processing apparatus 3000 acquires an XML document file to be a processing target via either the document acquisition unit 3114 or the document receiving unit 3134.

The data holding unit 3250 includes the file holding unit 3252, the tag mapping table holding unit 3254, and the annotation mapping table holding unit 3256. The file holding unit 3252 holds an XML document file, especially an XML document file described by a substance tag. The tag mapping table holding unit 3254 holds a tag mapping table in which a substance tag and a model tag are associated with each other. The annotation mapping table holding unit 3256 holds an annotation mapping table in which a substance annotation and a model annotation are associated with each other.

The data processing unit 3200 includes the document editing unit 3210, the search unit 3220, the mapping processing unit 3230, and the masking processing unit 3240. The document editing unit 3210 executes an editing processing of an XML document file in accordance with an input from a user. The main function of the document editing unit 3210 is realized by the basic function of the document processing apparatus 20 explained in the base technology, especially by the editing unit 24. As a top-down approach, a user may convert an XML document file described by a model tag set into an XML document file described by a substance tag. Furthermore, as a bottom-up approach, a user may create an XML document file by using a substance tag which is defined freely by a user from the beginning.

The document editing unit 3210 includes the tag renaming unit 3212 and the annotation renaming unit 3214. When a top-down approach is applied, the tag renaming unit 3212 creates a substance tag by renaming model tags to substance tags. At the time, the mapping recording unit 3234 of the mapping processing unit 3230 associates a substance tag and a model tag which is the origin of the substance tag, and records the tags in a tag mapping table. The annotation renaming unit 3214 serves in the same way, creating a substance annotation by renaming model annotations to substance annotations. The mapping recording unit 3234 associates a substance annotation and a model annotation which is the origin of the substance annotation, and records the annotations in an annotation mapping table. When a substance tag or a substance annotation is created in a top-down approach, the tag or annotation which is created is associated with automatically by the mapping recording unit 3234. On the other hand, in a bottom-up approach, the correspondence detecting unit 3232 of the mapping processing unit 3230 detects automatically a correspondence relation between a model tag and a substance tag, or between a model annotation and a substance annotation. A detecting method will be mentioned later.

The search unit 3220 searches for a tag or annotation from an XML document file. The search unit 3220 includes the tag search unit 3222 and the annotation search unit 3224. The tag search unit 3222 searches for a tag. For instance, in the case of the example previously described, when search is performed by using a model tag <employee> as a search key, the tag search unit 3222 detects a substance tag associated with the model tag <employee>, with reference to a tag mapping table. That is, the unit detects the substance tags, <manager> and <person in charge of license>, from an XML document file, and acquires the element data thereof.

The search is not limited to such a method in which search is performed in the order of from a model tag to a substance tag, another way is also possible, in which search is performed in the order of from a substance tag to a model tag then to a substance tag. For instance, it is assumed that the substance tag <section manager> is used in an XML document file A, and the substance tag <person in charge of license> is used in another XML document file B. In the case, the substance tag <person in charge of license> may be searched for from an XML document file B by using the substance tag <section manager> in an XML document file A, as a search key. In this case, the tag search unit 3222 identifies the model tag <employee> which is associated with the substance tag <section manager> in an XML document file A in a tag mapping table. The tag search unit 3222 then identifies the substance tag <person in charge of license> which is associated with the model tag <employee> in a tag mapping table. In this way, another substance tag which is mapped to the identical model tag can also be searched for. A tag mapping table is provided for each combination of a model tag set and a substance tag set. Of course, a substance tag which is included in the XML document file A and is mapped to the same model tag as another substance tag in the same file A, can be searched for by using the another substance tag as a search key.

The annotation search unit 3224 searches for an annotation. The annotation search unit 3224 also searches for a corresponding substance annotation from an XML document file by using a model annotation as a search key, in the same way as a tag search. Furthermore, another substance annotation mapped to the same model annotation can be searched for by using a substance annotation as a search key.

The mapping processing unit 3230 manages mapping of tags or annotations. The basic structure thereof is the same as that of the vocabulary connection by the VC unit 80 explained in the base technology. The mapping processing unit 3230 includes the correspondence detecting unit 3232 and the mapping recording unit 3234. The correspondence detecting unit 3232 detects a correspondence relation between a substance tag and a model tag, or between a substance annotation and a model annotation, in a bottom-up approach.

The correspondence detecting unit 3232 detects a correspondence relation with reference to a synonym table or a conceptual word table which has been provided in advance. In a synonym table, a combination of words which are in a synonym relation are described. For example, the words, “train” and “bicycle” and the like, are registered as synonym words for the word “car.” In the case where the model tag “car” is defined, and when a user defines the substance tag “train” in an XML document file, the correspondence detecting unit 3232 detects a correspondence relation between the model tag “car” and the substance tag “train” with reference to a synonym table, and the mapping recording unit 3234 then associates the both tags and records them in a tag mapping table.

A combination of words which are in a relation between a word representing the superordinate concept and a word representing the subordinate concept is described in a conceptual word table. For example, for the word “car”, the words, “luxury car” and “new model car” and the like, which are words representing subordinate concepts in relation to the word “car”, are registered. In the case where the model tag <car> is defined, and when a user defines the substance tag <luxury car> in an XML document file, the correspondence detecting unit 3232 detects a correspondence relation between the model tag <car> and the substance tag <luxury car>, with reference to a synonym table, and the mapping recording unit 3234 associates the both tags and records them in a tag mapping table.

In this way, the correspondence detecting unit 3232 detects a correspondence relation between tags with reference to both or either of a synonym table and a conceptual word table. The correspondence detecting unit 3232 operates the same way with respect to annotation. In a bottom-up approach, a user may explicitly map any model tag in any model tag set to a substance tag. When an explicit mapping is ordered, the mapping recording unit 3234 records a correspondence relation between a substance tag and a model tag in a tag mapping table. One model tag set may be associated with each of multiple types of substance tag sets, or multiple model tag sets be associated with one substance tag set.

The masking processing unit 3240 makes the information specified by a user closed. For example, it is assumed that information related to the name of an employee is not desired to be displayed for protection of personal information, when displaying an XML document held in the file holding unit 3252 on a screen. In this case, a user specifies the non-display target data by using the model tag <employee>. The masking processing unit 3240 detects a corresponding substance tag from an XML document file with reference to a tag mapping table. The masking processing unit then excludes “Kato” and “Hasegawa”, which are the element data of the corresponding substance tags, <section manager> and <person in charge of license>, from display targets. Specifically, an XML document file in which the non-display data is excluded is newly created by converting the XML document file with an XML style sheet. The data included in the XML document file newly created is an actual display target. The data can also be masked when an XML document file is transmitted to an external apparatus by the document transmitting unit 3132. In this case, an XML document file in which the non-display data is excluded is a transmission target. According to such a processing method, the element data in various substance tags which are mapped to an model tag, can be centrally made closed by specifying the non-display target data by using the model tag. In addition to being made closed, the corresponding data may be changed, for example, in the display color or font thereof. In this way, the masking processing unit 3240 can also change a display mode of the information specified by a user.

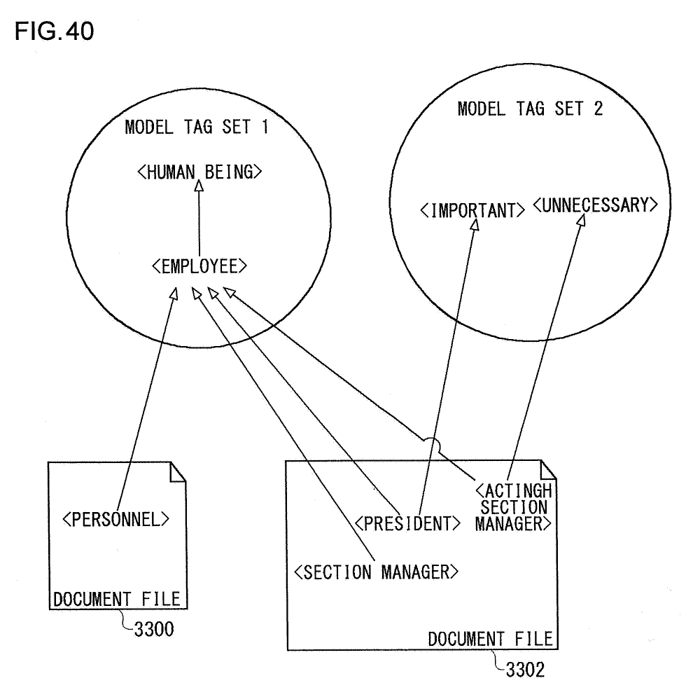

FIG. 40 is a schematic diagram which explains a mapping structure for mapping model tags to substance tags. Here, it is assumed that two types of model tag sets: the model tag set 1 and model tag set 2, are provided. The model tag set 1 and model tag set 2 may be provided by separate vendors. A substance tag included in the XML document file 3300 or the XML document file 3302 is a tag which a user sets arbitrarily, not a tag obtained by renaming a model tag. That is, it is premised on a bottom-up approach. The model tag set 1 includes the model tag <human being> and the model tag <employee> as a word representing a subordinate concept covered by the tag<human being>. It is assumed that for the word “employee”, the word “personnel” is associated as a synonym, and the words, “section manager”, “president”, “acting section manager” and the like, are associated as words representing the subordinate concepts covered by the word “employee”, in a synonym table and a conceptual word table. The model tag set 2 includes <important> and <unnecessary> as model tags.

The XML document file 3300 includes the substance tag <personnel>. The correspondence detecting unit 3232 detects that the words, “personnel” and “employee”, are in a synonym relation with reference to a synonym table. At the time, the mapping recording unit 3234 associates the substance tag <personnel> in the XML document file 3300, with the model tag <employee> in the model tag set 1, and records the tags in a tag mapping table.

The XML document file 3302 includes the substance tags, <section manager>, <president>, and <acting section manager>. The correspondence detecting unit 3232 detects that the word “section manager” is a word representing a subordinate concept covered by the word “employee”, with reference to a conceptual word table. At the time, the mapping recording unit 3234 associates the substance tag <section manager> in the XML document file 3302, with the model tag <employee> in the model tag set 1, and records the tags in a tag mapping table. The tags, <president> and <acting section manager>, are also associated with the model tag <employee>, and are recorded in the tag mapping table.

A user explicitly maps the substance tag <president> to the model tag <important> in the model tag set 2. Therefore, the mapping recording unit 3234 associates the substance tag <president> in the XML document file 3302, with the model tag <important> in the model tag set 2, and records the tags in a tag mapping table. Furthermore, a user explicitly maps the substance tag <acting section manager> to the model tag <unnecessary.> Therefore, these tags are associated with each other in a tag mapping table. Such mapping of the substance tag <president> to the model tag <important>, is based on a user's judgment. Therefore, given the same model tag set 2, the substance tag <president> may be mapped to the model tag <unnecessary>, or the tags, <section manager> and <acting section manager>, be mapped to the model tag <important>. Such mapping can be taken into consideration, if it is viewed that a middle manager is important. In particular, in the case of a model tag with respect to evaluation, such as “important” and “unnecessary”, a way of mapping may possibly change in accordance with a user's value judgment and evaluation standard. For example, a change in circumstances may happen during an operation of the system, in which the substance tag <acting section manager> should be mapped to <important>, not to <unnecessary>. In this case, a correspondence relation between a substance tag and a model tag in the tag mapping table will be changed. In this way, a correspondence relation between a substance tag and a model tag is desired to be changeable flexibly in accordance with circumstances. Furthermore, a mapping table may be set for each user. For example, user A maps <president> to <important>, whereas user B maps <president> to <unnecessary>. In this case, mapping tables for user A and user B are different from each other, even if combinations of a model tag set and a substance tag set are identical.

According to such a processing model, an existing XML document file can be mapped to one or more model tag sets. Therefore, the important element data in an XML document file can be easily searched for only by mapping an important substance tag to the model tag <important>, even if the XML document file is described by various substance tag sets. According to a bottom-up approach, it is not required that a user is forced to use a model tag or to create a substance tag based on a model tag. Therefore, separate substance tag sets can be connected together via a model tag set. For example, although the substance tag sets used in the development division and in the marketing division might be different from each other, the information of the both divisions can be rationally connected together via a common model tag set. In addition, when various types of model tag sets are provided, a substance tag can be searched for from various viewpoints.

### INDUSTRIAL APPLICABILITY

According to the present invention, the invention is effective for improving the convenience of a user in handling data included in a plurality of structured document files.

1. A document processing apparatus comprising:
a file holding unit which holds a child document file created by a schema inheriting a schema of a parent document file in which a plurality of tags are structured;
a tag renaming processing unit which changes a name of a substance tag, which is a tag in a child document file inheriting a model tag included in a parent document file, in accordance with a user's input direction; a tag mapping table holding unit which holds a tag mapping table in which a name of a substance tag included in a child document file and a name of a model tag which is the origin of the substance tag, are associated with each other; and
a tag data search unit which detects a name of a substance tag corresponding to a model tag, by a user's search direction input in which the name of the model tag is a search key, with reference to the tag mapping table, and detects the element data of the substance tag from a child document file, by using the name of the substance tag as a new search key.

2. The document processing apparatus according to claim 1, wherein the apparatus further comprises a related tag search unit which detects a model tag which is the origin of a substance tag specified by a user, with reference to the tag mapping table, and detects other substance tag inheriting the model tag, with reference to a plurality of tag mapping tables which are held in the tag mapping table holding unit.

3. A document processing apparatus comprising:
a file holding unit which holds a child document file created by a schema inheriting a schema of a parent document file in which a plurality of tags are structured;
an annotation renaming processing unit which changes a name of a substance annotation which is an annotation in a child document file inheriting a model annotation included in a parent document file, in accordance with a user's input direction;
an annotation mapping table holding unit which holds an annotation mapping table in which a name of a substance annotation included in a child document file and a name of a model annotation which is the origin of the substance annotation, are associated with each other;
an annotation setting unit which sets a substance annotation in the data which is included in a child document file and specified by a user; and
an annotation data search unit which detects a name of a substance annotation which corresponds to a model annotation, by a user's search direction input in which the name of the model annotation is a search key, with reference to the annotation mapping table, and further detects the data in which the substance annotation is set from a child document file, by using the name of the substance annotation as a new search key.

4. The document processing apparatus according to claim 3, wherein the apparatus further comprises a file transmitting unit which transmits a child document file to an external apparatus; and the annotation data search unit, using a model annotation as a search key, detects the data corresponding to the model annotation from the data included in a child document file, wherein the model annotation is an annotation which shows prohibition of data from being transmitted externally; and the file transmitting unit deters the data detected from being transmitted to an external apparatus.

5. A document processing apparatus comprising:
a document acquisition unit which acquires a structured document file described by a substance tag which belongs to a predetermined tag set;
a correspondence detecting unit which detects a substance tag included in the structured document file, and detects a model tag which is in a predetermined relation with the substance tag detected, among model tags which belong to a tag set different from the predetermined tag set;
a mapping recording unit which associates the substance tag and the model tag which are in the predetermined relation with each other, and records the tags in a tag mapping table; and
a tag search unit which, upon receiving user's search direction in which the model tag is a search key, detects the element data of the substance tag associated with the model tag in the tag mapping table, from a structured document file.

6. The document processing apparatus according to claim 5, wherein the apparatus further comprises: a data display unit which displays data included in a structured document file; and a display control unit which, upon receiving a user's input direction in which a model tag corresponding to the element data which is not a display target is specified, detects a substance tag associated with the model tag in the tag mapping table, and excludes the element data identified by the substance tag in the structured document file, from a display target.

7. The document processing apparatus according to claim 5, wherein the correspondence detecting unit detects a model tag of which name is in a synonym relation with the name of the substance tag detected from the structured document file, as a model tag which is in the predetermined relation with the substance tag, with reference to a synonym data table in which a combination of words which are in a synonym relation with each other is defined.

8. The document processing apparatus according to claim 5, wherein the correspondence detecting unit detects a model tag of which name is a superordinate concept covering the name of the substance tag detected from the structured document file, as a model tag which is in the predetermined relation with the substance tag, with reference to a conceptual data table in which a combination of words which are in a relation between the superordinate concept and the subordinate concept is defined.

9. A document processing method comprising:
changing a name of a substance tag which is a tag in a child document file inheriting a model tag included in a parent document file, in accordance with a user's input direction, wherein the child document file is created by a schema inheriting a schema in a parent document file in which a plurality of tags are structured; and
detecting a name of a substance tag corresponding to a name of a model tag, by a user's search direction input in which the name of the model tag is a search key, with reference to a tag mapping table in which a name of a substance tag included in a child document file and a name of a model tag which is the origin of the substance tag are associated with each other, and further detects the element data of the substance tag from the child document file, by using the name of the substance tag as a new search key.

10. A document processing method comprising:
changing a name of a substance annotation which is an annotation in a child document file inheriting a model annotation included in a parent document file, in accordance with a user's input direction, wherein the child document file is created by a schema inheriting a schema in a parent document file in which a plurality of tags are structured;
setting a substance annotation in the data which is included in the child document file and specified by a user; and
detecting a name of a substance annotation corresponding to a name of a model annotation, by a user's search direction input in which the name of the model annotation is a search key, with reference to an annotation mapping table in which a name of a substance annotation included in a child document file and a name of a model annotation which is the origin of the substance annotation are associated with each other, and further detects the data in which the substance annotation is set from the child document file, by using the name of the substance annotation as a new search key.

11. A document processing program product comprising:
a module which changes a name of a substance tag which is a tag in a child document file inheriting a model tag included in a parent document file, in accordance with a user's input direction, wherein the child document file is created by a schema inheriting a schema in a parent document file in which a plurality of tags are structured; and
module which detects a name of a substance tag corresponding to a name of a model tag, by a user's search direction input in which the name of the model tag is a search key, with reference to a tag mapping table in which a name of a substance tag included in a child document file and a name of a model tag which is the origin of the substance tag are associated with each other, and further detects the element data of the substance tag from the child document file, by using the name of the substance tag as a new search key.

12. A document processing program product comprising:
a module which changes a name of a substance annotation which is an annotation in a child document file inheriting a model annotation included in a parent document file, in accordance with a user's input direction, wherein the child document file is created by a schema inheriting a schema in a parent document file in which a plurality of tags are structured;
a module which sets a substance annotation in the data which is included in the child document file and specified by a user; and
a module which detects a name of a substance annotation corresponding to a name of a model annotation, by a user's search direction input in which the name of the model annotation is a search key, with reference to an annotation mapping table in which a name of a substance annotation included in a child document file and a name of a model annotation which is the origin of the substance annotation are associated with each other, and further detects the data in which the substance annotation is set from the child document file, by using the name of the substance annotation as a new search key.

13. A document processing method comprising:
acquiring a structured document file described by a substance tag which belongs to a predetermined tag set;
detecting a substance tag included in the structured document file, and further detecting a model tag which is in a predetermined relation with the substance tag detected, among model tags which belong to a tag set different from the predetermined tag set;
associating the substance tag and the model tag which are in the predetermined relation with each other and recording the tags in a tag mapping table; and
detecting the element data of a substance tag from the structured document file, upon receiving user's search direction in which a model tag is a search key, wherein the substance tag is associated with the model tag in the tag mapping table.

14. A document managing program product comprising:
a module which acquires a structured document file described by a substance tag which belongs to a predetermined tag set;
a module which detects a substance tag included in the structured document file, and further detects a model tag which is in a predetermined relation with the substance tag detected, among model tags which belong to a tag set different from the predetermined tag set;
a module which associate the substance tag and the model tag which are in the predetermined relation with each other and which records the tags in a tag mapping table; and
a module which detects the element data of a substance tag from the structured document file, upon receiving user's search direction in which a model tag is a search key, wherein the substance tag is associated with the model tag in the tag mapping table.
